(19) United States
(12) Patent Application Publication
(10) Pub. No.: US 2019/0308447 A1
(43) Pub. Date: Oct. 10, 2019

(54) CENTERLESS WHEEL ASSEMBLIES FOR VEHICLES

(71) Applicant: Orbis Wheels, Inc., Mill Valley, CA (US)

(72) Inventors: Marcus G. HAYS, San Rafael, CA (US); Scott STREETER, Santa Rosa, CA (US); Kalleheikko KANNISTO, Helsinki (FI); Stojan JANKOVIC, Subotica (RS); Brian SAID, Jupiter, FL (US)

(21) Appl. No.: 16/379,256

(22) Filed: Apr. 9, 2019

Related U.S. Application Data
(60) Provisional application No. 62/750,102, filed on Oct. 24, 2018.
(60) Provisional application No. 62/655,068, filed on Apr. 9, 2018.

(51) Int. Cl. B60B 19/00

(52) U.S. Cl. CPC B60B 19/00; B60B 21/02

(57) ABSTRACT

A vehicle is disclosed that may include a vertical axle, a support rod coupled to the vertical axle, and a wheel assembly coupled to the vertical axle via the support rod. The wheel assembly may include a centerless rim, a stationary hub coupled to the support rod and disposed at least partially within the centerless rim, and a roller guide supported by the stationary hub and shaped to roll along the centerless rim. The wheel assembly may be configured to rotate at least one hundred and seventy degrees relative to the vehicle.

### CROSS-REFERENCE TO RELATED APPLICATION

This application claims priority to U.S. Application No. 62/655,068 filed on Apr. 9, 2018, and U.S. Application No. 62/750,102 filed on Oct. 24, 2018, both of which are incorporated herein by reference in their entireties.

### FIELD

The present disclosure relates to centerless wheel assemblies for vehicles.

### BACKGROUND

Some vehicles use traditional wheels with spokes connecting the axle of the wheel to the tire. Vehicles that use traditional wheels have certain requirements for steering and other aspects associated with mounting the wheel. As described herein, some of these limitations of traditional wheels may be overcome with one or more embodiments of the present disclosure.

The subject matter claimed herein is not limited to embodiments that solve any disadvantages or that operate only in environments such as those described above. Rather, this section is only provided to illustrate one exemplary technology area where some embodiments described herein may be practiced.

### SUMMARY

One or more embodiments of the present disclosure may include a vehicle. The vehicle may include a vertical axle, a support rod coupled to the vertical axle, and a wheel assembly coupled to the vertical axle via the support rod. The wheel assembly may include a centerless rim, a stationary hub coupled to the support rod and disposed at least partially within the centerless rim, and a roller guide supported by the stationary hub and shaped to roll along the centerless rim. The wheel assembly may be configured to rotate at least one hundred and seventy degrees relative to the vehicle.

One or more additional embodiments may include a wheel assembly that includes a stationary hub. The stationary hub may include multiple arms extending outwardly from a central region of the stationary hub, with a support arm link shaped to interface with a support arm of a vehicle. The stationary hub may also include an axle connector projecting outward from a middle of the stationary hub, and a brake caliper. The wheel assembly may also include multiple roller guides, each supported at an end portion of one of the arms. The wheel assembly may additionally include a centerless rim that may be shaped to interface with the roller guides such that the roller guides roll along the centerless rim when the centerless rim rotates relative to the stationary hub. The centerless rim may include a rim gear with teeth oriented towards a middle of the centerless rim, and an internal slanted portion angled inwards towards the rim gear and shaped to interface with at least one of the roller guides. The centerless rim may additionally include an external slanted portion on an opposite side from the rim gear and angled inwards towards the rim gear and shaped to interface with at least another of the plurality of roller guides. The wheel assembly may also include a brake rotor physically coupled to the centerless rim such that slowing of the brake rotor causes a corresponding slowing of the centerless rim, where the brake rotor may be positioned to correspond to the brake caliper such that when the brake caliper is activated, the brake rotor is slowed.

It is to be understood that both the foregoing general description and the following detailed description are merely examples and explanatory and are not restrictive of the invention, as claimed.

Additional features and advantages of the disclosure will be set forth in the description which follows, and in part will be apparent from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE DRAWINGS

Example embodiments will be described and explained with additional specificity and detail through the use of the accompanying drawings in which:

FIG. 1 illustrates an example centerless wheel assembly;

FIG. 2 illustrates an example stationary hub assembly;

FIG. 3 illustrates a section-view of an example centerless rim assembly;

FIG. 4 illustrates another example centerless wheel assembly;

FIG. 5 illustrates an additional example centerless wheel assembly;

FIG. 6 illustrates an example vehicle, including various engines and/or motors associated with centerless wheels;

FIG. 7 illustrates the vehicle of FIG. 6 utilizing one or more lifts;

FIG. 8A illustrate an example centerless brake assembly and an example suspension assembly of an example centerless wheel assembly;

FIG. 8B illustrates the example centerless brake assembly of FIG. 8A;

FIGS. 8C and 8D illustrate the use of various sensors in conjunction with a centerless wheel assembly;

FIGS. 9A and 9B illustrate an example of a turning mechanism of an example vehicle;

FIGS. 9C-9F illustrate an example steering method that a vehicle using the turning mechanism of FIGS. 9A and 9B may use to maneuver the vehicle to the side;

FIGS. 9G-9I illustrate a vertical view of various embodiments of an example turning mechanism;

FIG. 9J illustrates an example vehicle utilizing an example turning mechanism;

FIGS. 9K-9N illustrate various other embodiments of the example turning mechanism;

FIGS. 10A-10C illustrate various views of another example centerless rim assembly;

FIG. 11 illustrates another example centerless rim;

FIGS. 12A and 12B illustrate various views of another example centerless wheel assembly;

FIGS. 13A-13C illustrate various views of an additional example centerless rim assembly;

FIGS. 14A and 14B illustrate various views of another example centerless rim assembly;

FIGS. 15A and 15B illustrate multiple views of another example centerless wheel assembly;

FIGS. 16A and 16B illustrate multiple views of another example centerless wheel assembly; and

FIGS. 17A and 17B illustrate various views of another example centerless wheel assembly.

### DETAILED DESCRIPTION

The present disclosure is generally directed to centerless wheel assemblies that may be used for vehicles. The principles of the present disclosure, however, are not limited to vehicles. For example, the centerless wheel assemblies themselves, or principles of operation thereof, may be applied to other circumstances or used in other ways. It will be understood that, in light of the present disclosure, the centerless wheel assemblies disclosed herein may include a variety of shapes, sizes, configurations, and arrangements. It will also be understood the centerless wheel assemblies may include any suitable number and combination of features, components, aspects, and the like. It will be further appreciated that the disclosed example embodiments of the centerless wheel assembly may be used in numerous locations, environments, and arrangements.

The present disclosure additionally relates to the use of a turning mechanism possible through the use of centerless wheel assemblies that permit the centerless wheel assembly to turn much further than traditional wheels. For example, in some embodiments of the present disclosure, the turning mechanism may permit the centerless wheel assembly to rotate significantly further relative to the vehicle than a traditional wheel, such as one hundred and eighty degrees of rotation relative to the vehicle.

Example embodiments of the centerless wheel assemblies are disclosed and described in detail below. It will be understood that different embodiments may have one or more different parts, components, features and aspects; and the different parts, components, features and aspects may not be required. Further, it will be understood that different embodiments may include various combinations of these parts, components, features and aspects depending, for example, upon the intended use of the centerless wheel assembly.

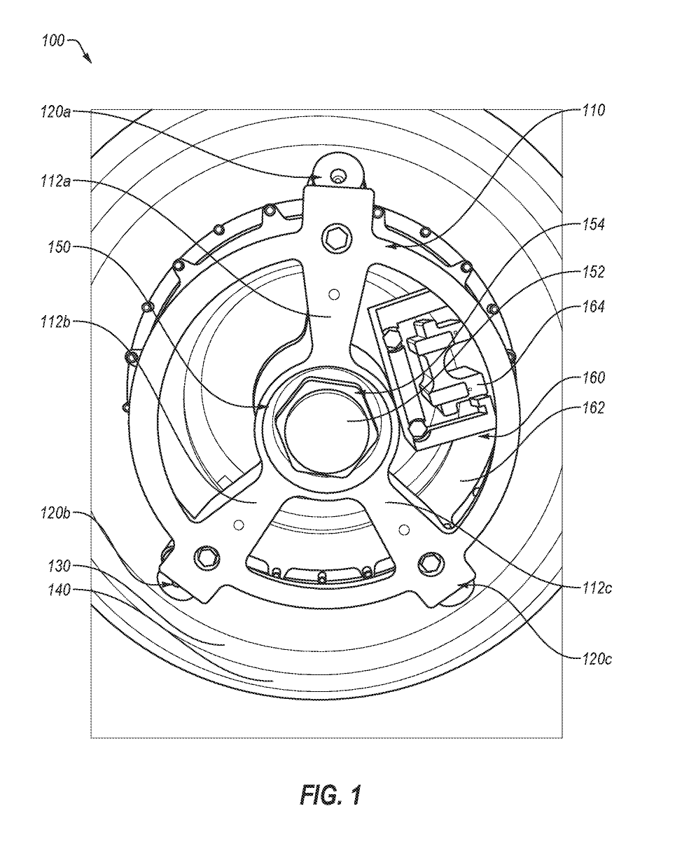

FIG. 1 illustrates an embodiment of a centerless wheel assembly 100, in accordance with one or more embodiments of the present disclosure. The centerless wheel assembly 100 may be configured to be retrofitted to an existing vehicle, such as an automotive vehicle using a traditional combustion engine and traditional drive train with axles spanning the vehicle. The centerless wheel assembly 100 may include a stationary hub 110, one or more roller guide assemblies 120 (e.g., the roller guide assemblies 120a-120c), a centerless rim 130, a tire 140, an axle assembly 150, and a centerless brake assembly 160. The stationary hub 110 may interface with the one or more roller guide assemblies 120a-120c. The stationary hub 110 may also interface with the axle assembly 150. The one or more roller guide assemblies 120a-120c may be configured to interface with and roll along the centerless rim 130. The centerless rim 130 may be configured to be fixedly coupled to the tire 140. The centerless rim 130 may also be configured to interface with the centerless brake assembly 160. In some embodiments, the centerless wheel assembly 100 may be configured to interface with a suspension assembly, hub assembly, motor assembly, and/or other component of a vehicle.

The stationary hub 110 may include any device or component that acts as a rim, frame, exoskeleton plate, and/or structure for the centerless wheel assembly 100 such that the stationary hub 110 may remain in a fixed orientation relative to the tire 140 as the tire 140 rotates. The stationary hub 110 may include any shape or profile. As illustrated in FIG. 1, the stationary hub 110 may include a generally circular shape with a front surface of the stationary hub 110 being substantially flat. The stationary hub 110 may include one or more arms 112a-112c to connect an inner portion of the stationary hub 110 to an outer portion of the stationary hub 110. The stationary hub 110 may be attached to a vehicle such that a front face of the stationary hub 110 may be generally parallel to a plane generally defined by a face of the centerless rim 130. The stationary hub 110 may also include a generally circular center portion such that the stationary hub 110 may interface with the axle assembly 150. The outer portion of the stationary hub 110 and/or the one or more arms 112a-112c may be shaped and/or angled such that the one or more roller guide assemblies 120a-120c may be rotatably coupled with the stationary hub 110.

The centerless rim 130 may include any device or component configured to roll along one or more roller guides 122a-122c and interface with the tire 140. The centerless rim 130 may be sized of a circumference and/or width comparable or similar to any standardized size of wheel used on automobiles, motorcycles, scooters, earth-moving equipment, military vehicle, aircraft, lawn and garden machines, planetary rovers, and/or any other vehicle in general. In some embodiments, the centerless rim 130 may enclose a generally cylindrical shape with two flat faces and one curved face. The centerless rim 130 may be configured to rotate about a line that passes perpendicularly through the two flat faces. The centerless rim 130 may contain a void of material within the centerless rim 130. In some embodiments, the centerless rim 130 may have a profile such that the tire 140 may be coupled to the outer portion of the centerless rim 130.

The centerless rim 130 and/or the one or more roller guides 122a-122c may include a coating that may reduce the friction that may be created by the interaction between the centerless rim 130 and the one or more roller guides 122a-122c and/or may prevent corrosion of the centerless rim 130. The coating may include, but is not limited to, any one and/or combination of the following: paint, zinc, cadmium, aluminum, chrome, nickel, nickel-chromium, iron oxide, silver, silicon nitride, one or more electro-coatings, one or more epoxy coatings, plastic coatings, resin coatings, Teflon coatings, etc.

The axle assembly 150 may include any device or component configured to couple the centerless wheel assembly 100 to a vehicle via the hub, axle, and/or other portion of the vehicle. The hub assembly may include an axle connector 152 and a nut 154. In some embodiments, the axle assembly 150 may couple to a vehicle via the axle connector 152. Additionally and/or alternatively, the axle assembly 150 may be fixedly coupled with the stationary hub 110 via the nut 154.

The centerless brake assembly 160 may include any device or component configured to apply force to the centerless rim 130 such that the centerless brake assembly 160 may slow the rotation of the centerless wheel assembly 100. The centerless brake assembly 160 may include a centerless rotor 162 and a brake caliper 164. In some embodiments, the centerless brake assembly 160 may be configured to function similar to disc brakes, brake rotors, and/or brake calipers that may be present on a vehicle.

In some embodiments, the centerless wheel assembly 100 may be configured to interface with one or more motor assemblies (not shown) which may be used to power the centerless wheel assembly 100. The one or more motor assemblies may include, but are not limited to, one or more electric, magnet, brushed, brushless, synchronous, and/or induction motors. The one or more motor assemblies may be configured such that the one or more motor assemblies may operate when wet. For example, the centerless wheel assembly 100 and/or the one or more motor assemblies may be configured to function while partially and/or complete submerged in water or other liquid.

The centerless wheel assembly 100 may contain one or more regenerative systems and may be configured to store energy generated by one or more devices and/or components of the centerless wheel assembly 100. For example, in some embodiments, the one or more motors may use energy stored in one or more batteries to drive the centerless wheel assembly 100. In some embodiments, when a brake system of the centerless wheel assembly 100 is engaged or when the centerless wheel assembly 100 is decelerating, the centerless wheel assembly 100 may act as a generator and may transfer a portion of the momentum stored in the centerless wheel assembly 100 into one or more batteries. In some embodiments, the centerless wheel assembly 100 with one or more regenerative systems may be coupled with the back axle of a vehicle. Additionally and/or alternatively, the centerless wheel assembly 100 with one or more regenerative systems may be coupled with the front axle of a vehicle such that the one or more regenerative systems may recover optimal energy due to braking while maintaining vehicle stability.

The centerless wheel assembly 100 may be configured to be retrofitted to one or more conventional wheel assemblies including, but not limited to, conventional wheels, hubs, and/or axles. In some embodiments, the centerless wheel assembly 100 may be configured to be coupled with any type of vehicle including, but not limited to, automobiles, motorcycles, scooters, earth-moving equipment, military vehicle, aircraft, lawn and garden machines, planetary rovers, and/or any other vehicle in general.

In some embodiments, the centerless wheel assembly 100 may act as a heat-sink for the one or more motors. For example, the centerless wheel assembly 100 may act as a heat-sink such that the temperature of the one or more motor assemblies may be lower than the one or more motors of a conventional wheel assembly during and/or after operation of the vehicle and/or the centerless wheel assembly 100. In some embodiments, the centerless wheel assembly 100 may contain a heating coil (not shown) that may be coupled with and/or form part of the centerless rim 130 and/or the stationary hub 110. For example, the heating coil may be an electric heating coil and may be powered by an inductive electric connection. In some embodiments, the heating coil may facilitate the removal of ice, snow, and/or other material from the centerless wheel assembly 100.

In some embodiments, the centerless wheel assembly 100 may have a larger polar moment of inertia than wheel assemblies on conventional vehicles. In some embodiments, the configuration of the centerless wheel assembly 100 may require less force to decelerate and accelerate the centerless rim 130 and/or tire 140 than a conventional vehicle due to the larger polar moment of inertia of the centerless wheel assembly 100. Additionally or alternatively, in some embodiments, the centerless wheel assembly 100 may have a lower moment of inertia as compared to wheel assemblies on conventional vehicles. For example, the triangular configuration of the stationary hub 110 may permit the use of a ring design that is significantly lighter than the rims of conventional wheel assemblies. Additionally or alternatively, the forces acting on the axle of the centerless wheel assembly 100 may be distributed over a wider area than a conventional wheel. For example, such forces acting on the axle may be distributed across the two lower roller guide assemblies 120b and 120c of the triangular shaped stationary hub 110.

Modifications, additions, or omissions may be made to the centerless wheel assembly 100 of FIG. 1 without departing from the scope of the present disclosure. For example, any of the features and/or principles described with reference to other embodiments of the present disclosure may be applied to the centerless wheel assembly 100 illustrated in FIG. 1.

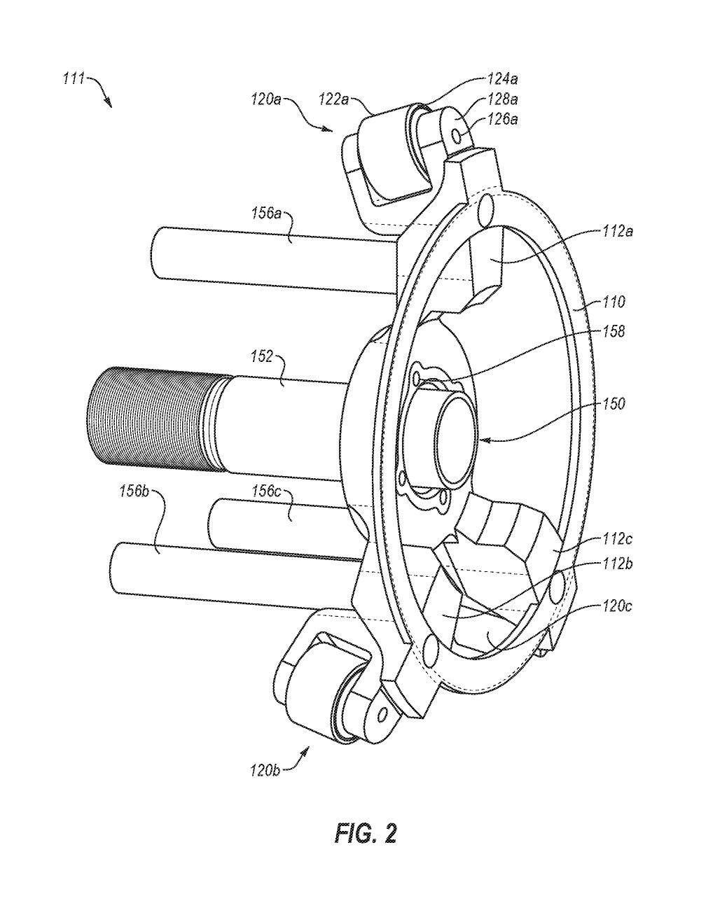

FIG. 2 illustrates an embodiment of a stationary hub assembly 111. The stationary hub assembly 111 may include the stationary hub 110, the one or more roller guide assemblies 120a-120c, the axle assembly 150, and one or more support rods 156a-156c. The stationary hub assembly 111 may be fixedly coupled with a vehicle via a suspension assembly, a hub assembly, motor assembly, and/or other assembly. The hub assembly 111 may be configured to remain in a fixed orientation relative to the centerless rim (not shown in FIG. 2) as the centerless rim rotates. The roller guides 122a, 122b, and/or 122c may roll along the centerless rim as the centerless rim rotates.

One or more of the components of the stationary hub assembly 111 may be similar or comparable to the commonly named and numbered components of FIG. 1. For example, the stationary hub 110 and the one or more roller guide assemblies 120a-120c of FIG. 2 may be similar or comparable to the stationary hub 110 and the one or more roller guide assemblies 120a-120c of FIG. 1, respectively. As illustrated in FIG. 2, the stationary hub assembly 111 may include one or more different components and/or structures than centerless wheel assembly 100 of FIG. 1. For example, the stationary hub 110 of FIG. 2 may be shaped differently than the stationary hub 110 of FIG. 1.

The stationary hub 110 may contain an outer ring that may be generally circular in shape. The stationary hub 110 may also include an inner ring that may be generally circular in shape. The inner ring of the stationary hub 110 may be substantially flat and may generally form a plane. In some embodiments, the plane generally created by the front face of outer ring of the stationary hub 110 and the plane generally created by the front face of the inner ring of the stationary hub 110 may be substantially parallel. In some embodiments, the front face of inner ring of the stationary hub 110 may be recessed back from the outer ring of the stationary hub 110. In some embodiments, the inner ring of the stationary hub 110 may be coupled to the outer ring of the stationary hub 110 via the one or more arms 112a-112c. In these and other embodiments, the inner ring may be thicker than the outer ring. For example, the inner ring may be approximately between two and five times as thick as the outer ring. In some embodiments, the inner ring may be seated against an existing component of a vehicle when retrofitting the wheel assembly to an existing vehicle.

The one or more roller guide assemblies 120a-120c may include any device or component configured to be rotatably coupled with the back surface of the stationary hub 110 and interface with the centerless rim 130. The one or more roller guide assemblies 120a-120c may be coupled with the stationary hub 110 via the one or more arms 112a-112c.

The one or more roller guide assemblies 120a-120c may include one or more roller guides 122a-122c, one or more sets of bearings 124a-124c, one or more shafts 126a-126c, and one or more bearing housings 128a-128c. The one or more roller guides 122a-122c may be coupled with the one or more sets of bearings 124a-124c such that the one or more roller guides 122a-122c may rotate. The one or more roller guides 122a-122c may be coupled with the one or more shafts 126a-126c such that the one or more shafts 126a-126c act as an axle and facilitate rotation of the one or more roller guides 122a-122c about the one or more shafts 126a-126c. The one or more shafts 126a-126c may be coupled with the one or more bearing housings 128a-128c. For example, the one or more shafts 126a-126c may be fixedly coupled with the one or more bearing housings 128a-128c. The top face of the one or more bearing housings 128a-128c may be generally parallel with the plane created by the top surface of the one or more arms 112a-112c. In some embodiments, the top face of the one or more bearing housings 128a-128c may sit at an angle as compared with the plane created by the top surface of the one or more arms 112a-112c. In some embodiments, the ends of the one or more shafts 126a-126c may be generally parallel to the plane created by the top face of the one or more bearing housings 128a-128c.

The one or more roller guides 122a-122c may be shaped to roll along the centerless rim 130 as the centerless rim 130 rotates. In some embodiments, the one or more roller guide assemblies 120a-120c may allow the centerless rim assembly 102 to operate at a lower temperature than the wheel/axle combination of convention wheels.

The one or more sets of bearings 124a-124c may be configured such that the one or more roller guides 122a-122c may swivel and move reactionary to a directional change in force that the centerless rim 130 exerts on the one or more roller guides 122a-122c.

In some embodiments, the one or more sets of roller guides 122a-122c may be allowed to swivel and/or rotate in response to one or more thrust and/or axial loads placed on the one or more roller guides 122a-122c such that the one or more roller guides 122a-122c may maintain contact with the centerless rim 130 and/or reduce friction between the one or more roller guides 122a-122c and the centerless rim 130.

The one or more roller guide assemblies 120a-120c may be configured to float such that the one or more roller guide assemblies 120a-120c may maintain contact with the centerless rim 130 if the centerless rim 130 is jostled and/or comes into contact with another object. The one or more roller guide assemblies 120a-120c may be located at an angle that may be generally parallel with the inner portion of the centerless rim 130. In some embodiments, the roller guide assemblies 120a-120c may be configured to float by applying a spring-loading force to the roller guide assemblies 120a-120c such that the roller guide assemblies 120a-120c may be biased by the spring force towards the centerless rim. As another example, the roller guide assemblies 120a-120c may be disposed within a channel that curves towards the centerless rim 130 such that as the roller guide assemblies 120a-120c are displaced in a radial direction relative to the front face of the stationary hub 110, a corresponding displacement may occur in a circumferential direction. Additionally or alternatively, the roller guide assemblies 120a-120c may be configured to be moveable along a circumferential direction, such as by the use of multiple pre-drilled bolt holes or a channel along which the roller guide assemblies 120a-120c and/or the associated arms 112a-112c. In some embodiments, the centerless rim 130 may contain one or more grooves that may run along the centerless rim 130 in a circumferential direction. For example, the one or more grooves may run along the centerless rim 130 in a way that may facilitate the removal of liquid, debris, and/or other materials and/or obstructions from within the centerless rim 130.

The axle assembly 150 may contain an axle connector 152 and an axle coupler 158. The axle assembly 150 may be coupled to the stationary hub 110 via the axle coupler 158. The axle connector 152 may include any device or component that may be cylindrical in shape and may interface with the axle coupler 158 and the vehicle via the hub, axle, and/or other component of the vehicle. In some embodiments, the axle connector 152 may include a portion that may contain external threads such that the axle connector 152 may be coupled to the vehicle via hub, axle, and/or other component of the vehicle by a fastener and/or may engage a set of threads that may be located on the hub, axle, and/or other component of the vehicle. In some embodiments, the axle assembly 150 and/or the axle connector 152 may connect the stationary hub 110 to an additional stationary hub.

The one or more support rods 156a-156c may include any device or component that may couple with the stationary hub 110 and provide stability to the stationary hub assembly 111. The one or more support rods 156a-156c may be coupled with the one or more arms 112a-112c of the stationary hub 110. In addition, the one or more support rods 156a-156c may extend from the stationary hub 110 and be coupled with the vehicle via the hub, axle, and/or other component of the vehicle.

Modifications, additions, or omissions may be made to the stationary hub assembly 111 of FIG. 2 without departing from the scope of the present disclosure. For example, any of the features and/or principles described with reference to other embodiments of the present disclosure may be applied to the stationary hub assembly 111 illustrated in FIG. 2.

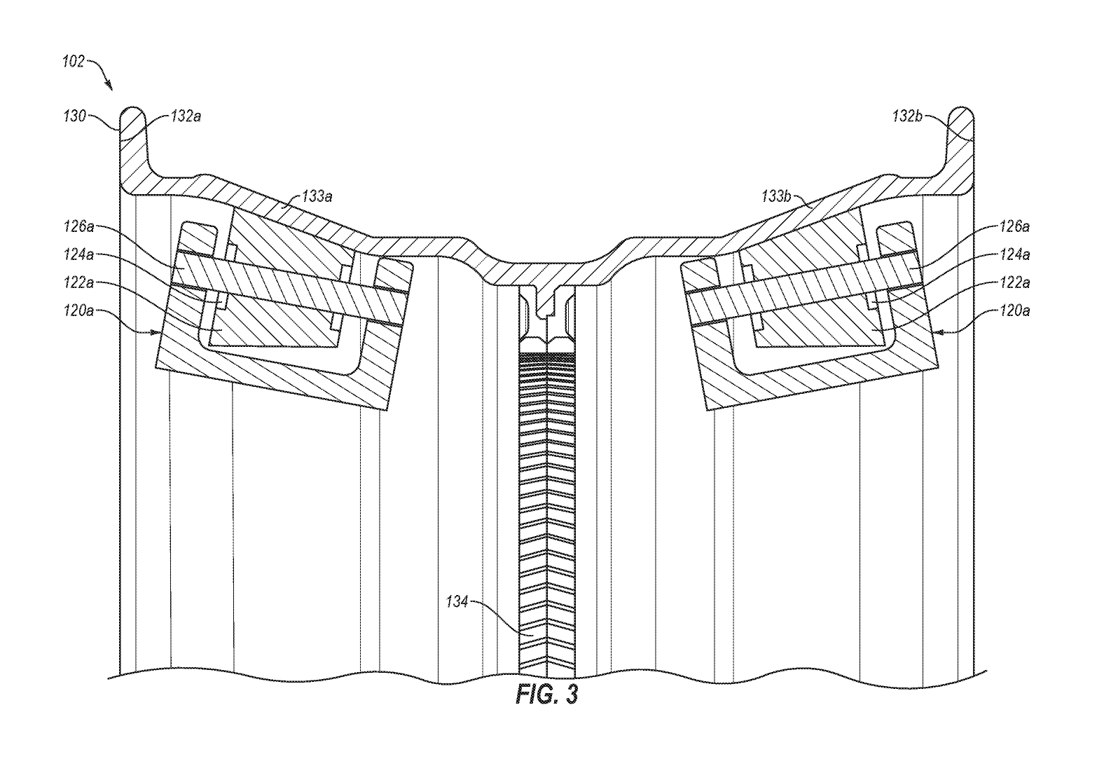

FIG. 3 illustrates a section-view of an example centerless rim assembly 102. The centerless rim assembly 102 of FIG. 3 may include one or more roller guide assemblies 120a-120c and the centerless rim 130. The centerless rim 130 may be configured to interface with the one or more roller guide assemblies 120a-120c.

One or more of the components of the centerless rim assembly 102 may be similar or comparable to the commonly named components of FIGS. 1-2. For example, the one or more roller guide assemblies 120a-120c and the centerless rim 130 of FIG. 3 may be similar or comparable to the one or more roller guide assemblies 120a-120c and the centerless rim 130 of FIGS. 1-2, respectively. As illustrated in FIG. 3, the centerless rim assembly 102 may include one or more different components and/or structures than the centerless rim assembly 102. For example, the one or more roller guide assemblies 120a of FIG. 3 may be shaped differently than the one or more roller guide assemblies 120a-120c of FIGS. 1-2.

The centerless rim 130 may be configured to interface with the one or more roller guide assemblies 120a-120c. As illustrated in FIG. 3, a barrel of the centerless rim 130 may have a profile that is generally concave in shape with one or more lip portions 132a-132b. In some embodiments, the one or more lip portions 132a-132b may function to retain a tire on the centerless rim 130. In some embodiments, the centerless rim 130 may contain a gear 134 within the inner circumference of the centerless rim 130. In some embodiments, the centerless rim 130 may contain one or more angled portions 133a-133b. The one or more angled portions 133a-133b may each generally form a plane. In some embodiments, an inner face of the one or more angled portions 133a-133b may face in an outward direction and/or in a direction away from a centerline of the inner circumference of the centerless rim 130. In some embodiments, the inner face of the one or more angled portions 133a-133b may interface with the one or more roller guides 122a-122c.

The gear 134 may include a device or component with teeth such that the relationship between the speeds of the centerless rim 130 and the devices and/or components that may drive the centerless rim 130 may be altered. The gear 134 may be formed as part of the inner portion of the centerless rim 130 or may be a separate device and/or component that is coupled with the centerless rim 130. For example, the gear 134 may be an internal gear and may run parallel to the inner circumference of the centerless rim 130. In some embodiments, the gear 134 may run parallel with the centerline of the inner circumference of the centerless rim 130, effectively separating the centerless rim 130 into two equal halves. The gear 134 may include any type of gear including, but not limited to, a herringbone, spur, helical, bevel, and/or worm gear. In some embodiments, the gear may include an arrow-point-shaped or chevron-shaped profile.

The one or more roller guide assemblies 120a-120c may include one or more roller guides 122a-122c, one or more sets of bearings 124a-124c, and one or more shafts 126a-126c. The profile of the one or more roller guides 122a-122c may be any size and/or shape. The one or more roller guides 122a-122c may be coupled with the one or more shafts 126a-126c such that the one or more roller guides 122a-122c rotate around the one or more shafts 126a-126c. In some embodiments, the one or more shafts 126a-126c are configured such that they may not be generally perpendicular with a front face the centerless rim 130 and/or the infer face of the one or more angled portions 133a-133b.

As illustrated in FIG. 3, the profile of the one or more roller guides 122a-122c may be frustoconical in shape, such that a cut-away view of the roller guides appears to be trapezoidal. In some embodiments, one or more sides of the roller guides 122a-122c may be configured to be generally parallel with the profile of centerless rim 130, such that the one or more sides of the one or more roller guides 122a-122c may maintain contact with the centerless rim 130 during rotation of the centerless rim 130 and/or the one or more roller guides 122a-122c. In some embodiments, the one or more sides of the roller guides 122a-122c may be configured such that the one or more sides of the roller guides 122a-122c may not be generally parallel to the axis of rotation created by the one or more shafts 126a-126c. For example, the axis of rotation of the one or more shafts 126a-126c may be generally coincident with a line running through the apex and the center of the base of the cone of the frustoconical shape. In these and other embodiments, such a line may or may not be parallel with any portions or facets of the centerless rim 130.

In some embodiments, the roller guides 122a-122c may take any other shape or profile. In some embodiments, the roller guides 122a-122c may include a generally similar shape to that illustrated in FIG. 3, with one or more additional features or anomalies. For example, the roller guides 122a-122c may include one or more grooves or channels in the roller guides 122a-122c. Such grooves or channels may run generally parallel with the direction of rotation of the roller guides 122a-122c, generally perpendicular with the direction of the rotation of the roller guides 122a-122c, and/or some other angled orientation therebetween. In addition, in some embodiments, the roller guides 122a-122c may include one or more deep groove bearings, one or more cathedral bearings, and/or one or more of another type of bearing that may be designed to function under axial and/or radial loads.

Modifications, additions, or omissions may be made to the centerless rim assembly 102 of FIG. 3 without departing from the scope of the present disclosure. For example, any of the features and/or principles described with reference to other embodiments of the present disclosure may be applied to the centerless rim assembly 102 illustrated in FIG. 3.

FIG. 4 illustrates another example centerless wheel assembly 200, in accordance with one or more embodiments of the present disclosure. The centerless wheel assembly 200 may include a stationary hub 210, one or more roller guide assemblies 220a-220c, a centerless rim 230, and a floater assembly 270. In some embodiments, the stationary hub 210 may interface with the one or more roller guide assemblies 220a-220c. The one or more roller guide assemblies 220a-220c may be configured to interface with and roll along the centerless rim 230. The centerless rim 230 may be configured to be fixedly coupled to a tire (not shown). The floater assembly 270 may also be configured to interface with the centerless rim 230.

One or more of the components of the centerless wheel assembly 200 may be similar or comparable to the commonly named components of FIGS. 1, 2, and/or 3. For example, the stationary hub 210, the one or more roller guide assemblies 220a-220c, and the centerless rim 230 of FIG. 4 may be similar or comparable to the stationary hub 110, the one or more roller guide assemblies 120a-120c, and the centerless rim 130 of FIGS. 1, 2, and/or 3, respectively. As illustrated in FIG. 4, the centerless wheel assembly 200 may include one or more different components and/or structures than centerless wheel assembly 100, the stationary hub assembly 111, and the centerless rim assembly 102 of FIGS. 1, 2, and/or 3. For example, the stationary hub 210 of FIG. 4 may be shaped differently than the stationary hub 110 of FIGS. 1, 2, and/or 3. In addition, the centerless wheel assembly 200 may contain a floater roller 272 that may not be illustrated in FIGS. 1, 2, and/or 3.

The floater assembly 270 may include any device or component coupled with the stationary hub 210 and configured to contact the centerless rim 230. The floater assembly 270 may include the floater roller 272 and a floater adjustor 274. The floater roller 272 may be coupled with stationary hub 210. In some embodiments, the floater roller 272 may be hingedly coupled with stationary hub 210, which may allow the floater roller 272 to engage and/or disengage with the centerless rim 230.

The floater adjustor 274 may include a device or component that may be coupled with the stationary hub 210 and may interface with the floater roller 272 such that movement of the floater adjustor 274 enacts a corresponding movement of the floater roller 272. For example, the floater adjustor 274 may move in a generally downward direction and cause the floater roller 272 to correspondingly move in a generally upward direction until the floater roller 272 engages with the centerless rim 230 (e.g., an opposite direction orientation/implementation). Additionally and/or alternatively, the floater adjustor 274 may move in a generally upward direction and cause the floater roller 272 to correspondingly move in a generally upward direction until the floater roller 272 engages with the centerless rim 230 (e.g., a same direction orientation/implementation). Additionally and/or alternatively, the floater adjustor 274 may move in a generally downward direction and cause the floater roller 272 to correspondingly move in a generally downward direction so that the floater roller 272 disengages and/or avoids contact with the centerless rim 230.

In some embodiments, the height of the various devices or components of the floater assembly 270 may be adjusted manually by a user of the vehicle via remote and/or direct contact with the floater assembly 270. Additionally and/or alternatively, the height of the various devices or components of floater assembly 270 may be adjusted automatically with respect to predetermined settings. In some embodiments, the floater assembly 270 may include one or more servo motors and/or one or more controllers which may be used to adjust the floater assembly 270.

In some embodiments, the floater assembly 270 may be utilized to facilitate the separation of the centerless rim assembly 230 from the stationary hub assembly 210. Additionally or alternatively, the floater assembly 270 may be utilized to adjust any of the orientation and/or location of the floater roller 272 relative to other roller guide assemblies.

Modifications, additions, or omissions may be made to the centerless wheel assembly 200 of FIG. 4 without departing from the scope of the present disclosure. For example, any of the features and/or principles described with reference to other embodiments of the present disclosure may be applied to the centerless wheel assembly 200 illustrated in FIG. 4.

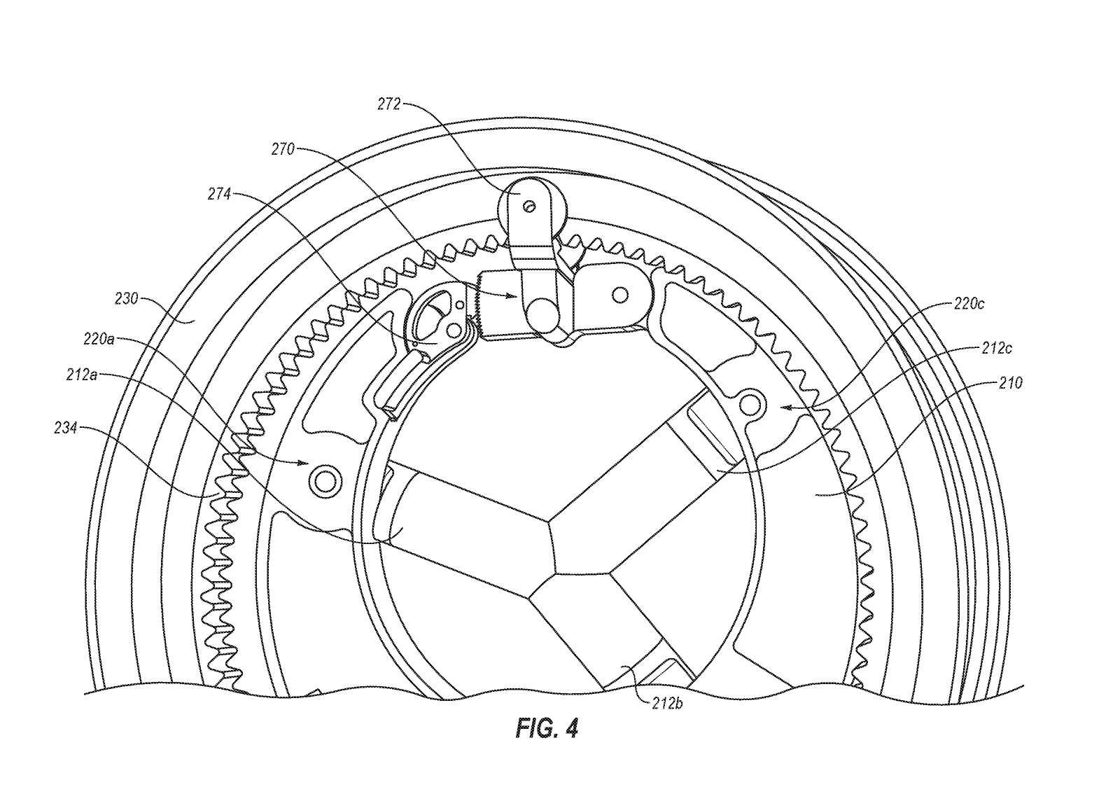

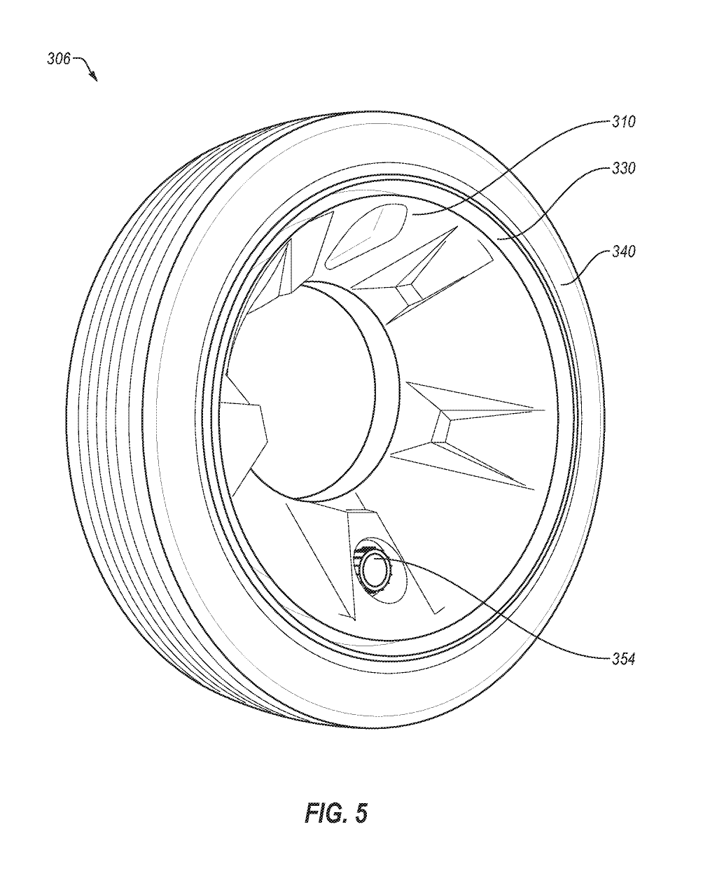

FIG. 5 illustrates an example of a centerless wheel assembly 306. The centerless wheel assembly 306 may include a stationary hub 310, a centerless rim 330, a tire 340, and a nut 354. As illustrated in FIG. 5, the stationary hub 310 may interface with the centerless rim 330 (e.g., via one or more roller guides coupled to a back side of the stationary hub, not shown). The centerless rim 330 may be configured to be fixedly coupled to the tire 340. The nut 354 may interface with the stationary hub 310 and a portion of the axle and/or hub of a vehicle. Additionally or alternatively, the nut 354 may interface with one or more components on a rear side of the centerless wheel assembly 306, such as a steering component, a centerless hub, etc.

Modifications, additions, or omissions may be made to the centerless wheel assembly 306 of FIG. 5 without departing from the scope of the present disclosure. For example, any of the features and/or principles described with reference to other embodiments of the present disclosure may be applied to the centerless wheel assembly 306 illustrated in FIG. 5.

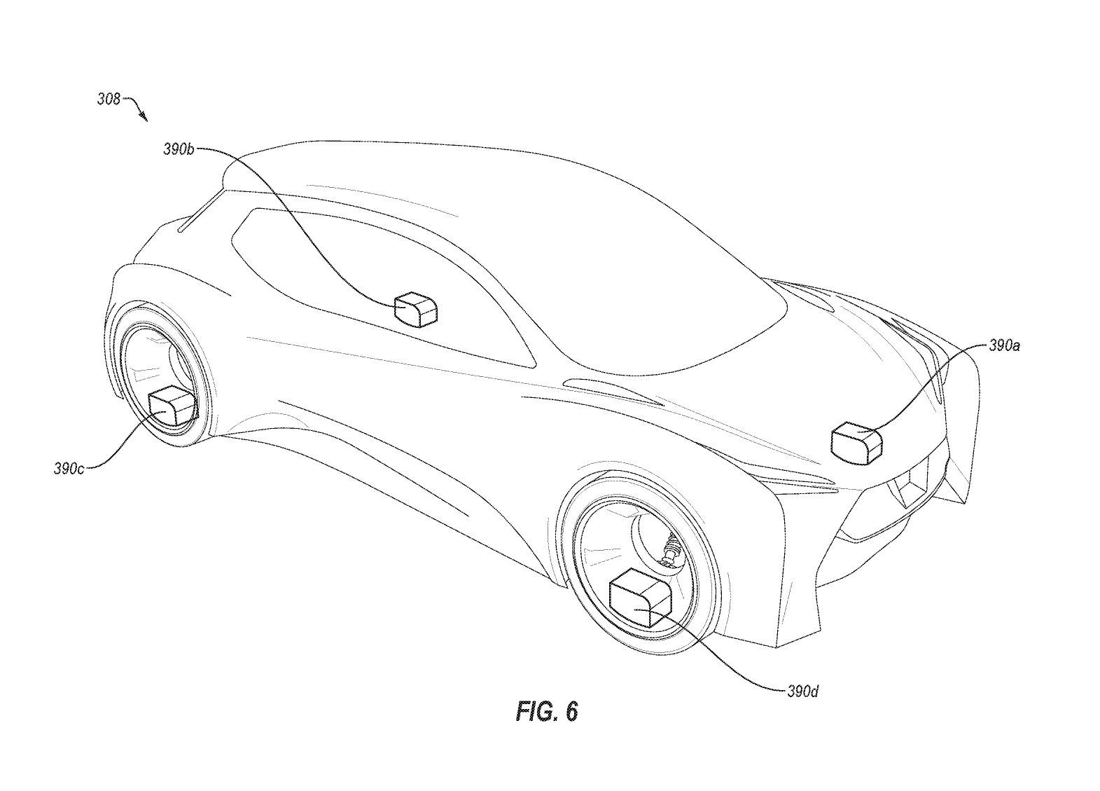

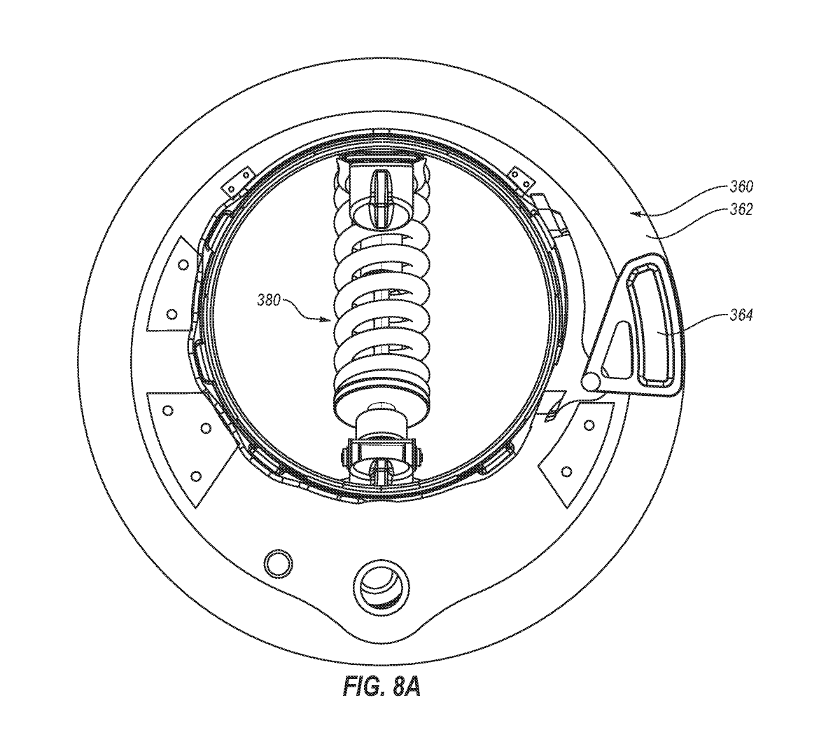

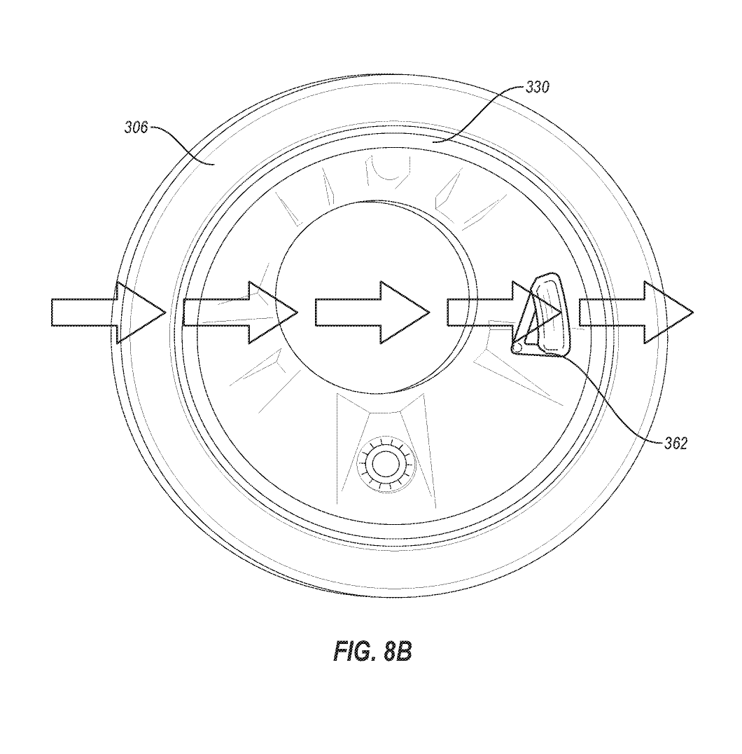

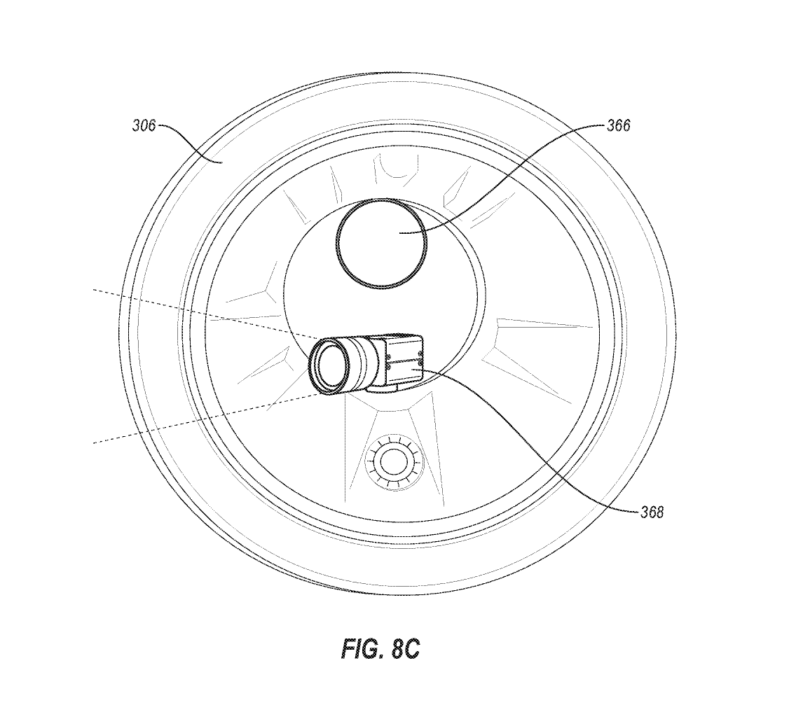

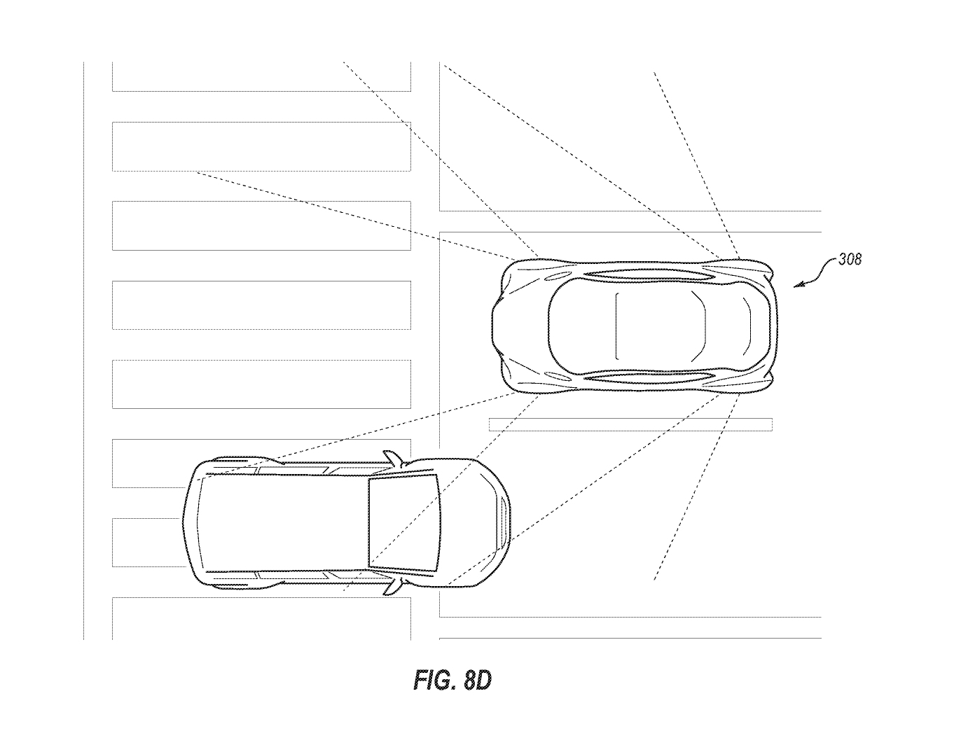

FIG. 6 illustrates an example vehicle, including various engines and/or motors associated with centerless wheels, in accordance with one or more embodiments of the present disclosure. The vehicle 308 may include one or more centerless wheel assemblies (such as the centerless wheel assembly 306 illustrated in FIG. 5), one or more centerless brake assemblies (such as the brake assembly 360 illustrated in FIGS. 8A and 8B), one or more suspension assemblies (such as the suspension assembly 380 illustrated in FIGS. 8A and 8B), and one or more motors 390 (such as the motors 390a-390d). The one or more centerless wheel assemblies may be coupled to the centerless brake assembly and/or the centerless suspension assembly. In addition, the one or more centerless wheel assemblies may be coupled with the one or more motor assemblies. The centerless suspension assembly may be coupled to the vehicle. The one or more centerless wheel assemblies, the one or more centerless brake assemblies, and/or the one or more motors 390 may be directly coupled to the vehicle 308 and/or may be indirectly coupled to the vehicle 308 via the centerless suspension assemblies.

One or more of the components of the vehicle 308 may be similar or comparable to the commonly named components of FIGS. 1-4. For example, the one or more centerless wheel assemblies 306 and the one or more centerless brake assemblies (such as the brake assemblies 360 illustrated in FIGS. 8A and 8B) may be similar or comparable to the one or more centerless wheel assemblies 100, the one or more centerless rim assemblies 102, the one or more centerless wheel assemblies 200, and/or the centerless brake assembly 160 of FIGS. 1-4, respectively. As illustrated in FIG. 6, the centerless wheel assembly 306 may include one or more different components and/or structures than centerless wheel assembly 100, the centerless rim assembly 102, and the centerless wheel assembly 200 of FIGS. 1, 2, and 4. For example, the stationary hub 310 of FIG. 4 may be shaped differently than the stationary hub 110 of FIGS. 1, 2, and 4.

In some embodiments, the vehicle 308 may contain one or more assemblies and/or components that are modular and/or interchangeable. For example, the one or more centerless wheel assemblies 306 may be configured such that the one or more centerless wheel assemblies 306 may be interchanged with the one or more other centerless wheel assemblies. Additionally and/or alternatively, the one or more centerless wheel assemblies 306 may be coupled with the vehicle 308 in any one of the four locations suited for coupling with the one or more centerless wheel assemblies 306. In some embodiments, the one or more centerless brake assemblies 360, one or more suspension assemblies 380, one or more motors 390, and/or other assemblies and/or components may be modular and/or interchangeable.

In some embodiments, the vehicle 308 may be an autonomous vehicle. Additionally and/or alternatively, the vehicle 308 may utilize a driver to operate the vehicle 308. In some embodiments, the vehicle 308 may be partially autonomous such that the vehicle 308 may perform some maneuvers without the input of a driver and may utilize input from a driver to perform other maneuvers.

In some embodiments, the one or more centerless wheel assemblies 306 may be configured to be coupled with any type of vehicle including, but not limited to, automobiles, all-terrain vehicles, motorcycles, aircrafts, and/or watercrafts.

In some embodiments, the vehicle 308 may be configured to operate using a conventional combustion engine and/or using conventional automobile steering mechanisms. In some embodiments, the vehicle 308 may be configured to operate using one or more motors 390, such as the motors 390a-390d. For example, the configuration of the vehicle 308 may replace the need for a conventional combustion engine, conventional hybrid engine, and/or conventional electric engine.

In some embodiments, the one or more motors 390 may be powered by one or more batteries. The one or more motors 390 may be coupled with the one or more centerless wheel assemblies 306 to drive the centerless wheel assemblies. In some embodiments, the one or more motors 390 may be more easily accessible and/or easily replaceable than conventional combustion engines. For example, in some embodiments, the one or more motors 390 may be accessible by removing the one or more centerless wheel assemblies 306, the one or more brake assemblies 360, and/or the one or more suspension assemblies 380.

In some embodiments, the vehicle 308 may be equipped with one or more motors 390 for each of the one or more centerless wheel assemblies 306. In some embodiments, the vehicle 308 may be designed such that the space in the vehicle generally used for a conventional combustion engine may be used for other purposes. Additionally and/or alternatively, the vehicle 308 of FIG. 6, equipped with one or more motors 390 for each of the one or more centerless wheel assemblies 306, may be substantially lighter than a vehicle equipped with a conventional combustion engine.

The various motors 390a-d may be used in a variety of ways in a variety of circumstances as explained herein.

In some circumstances, the vehicle 308 may use one of the one or more motors 390a-390d for operation. For example, the vehicle 308 may use the motor 390a for operation when the vehicle is operating at highway speeds or some other speed that is optimum or efficient for the vehicle 308 to travel.

In some circumstances, the vehicle 308 may utilize two of the one or more motors 390a-390d. For example, the vehicle 308 may use two of the one or more motors 390b and 390c to power the vehicle 308 during normal operation. Additionally and/or alternative, the vehicle 308 may use the one or more motors 390b-390c when traveling on relatively flat terrain and/or at lower speeds in order to promote efficiency.

In some circumstances, the vehicle 308 may use all four of the motors 390a-390d to power the centerless wheel assemblies 306. For example, the vehicle 308 may utilize all four of the motors 390a-390d to power the one or more centerless wheel assemblies 306 located in the front and the rear of the vehicle 308 when traveling uphill, accelerating quickly, and/or at higher speeds. In some embodiments, the vehicle 308 may use four of the one or more motors 390a-390d, with each of the one or more motors 390a-390d powering one of the one or more centerless wheel assemblies 306, such that the vehicle 308 may have four-wheel drive capabilities. In these and other embodiments, the use of the motors 390a-d may be powered at different speeds to prevent slippage and/or to provide greater traction.

In some circumstances, the vehicle 308 may use the one or more motors 390a-390d to regenerate power. For example, the vehicle 308 may use the movement of the vehicle 308 and/or the one or more motors 390a-390d to regenerate power and/or recharge the one or more batteries. For example, the one or more motors 390 may be configured to cooperate with the one or more centerless brake assemblies 360 such that power may be regenerated when the one or more centerless brake assemblies 360 are used to slow the vehicle 308. As another example, the one or more motors 390 may be coupled via clutch or other mechanism to the centerless wheel assemblies 306 such that the motors 390 may be selectively engaged or disengaged from the centerless wheel assemblies 306. For example, if the vehicle 308 is traveling faster than the motors 390 would drive the vehicle 308, the clutch may be engaged such that the motors 390 impose a load on the vehicle 308, slowing it down and generating power in the motor (e.g., the motor in effect becomes a generator). Additionally and/or alternatively, the one or more motors 390 may be configured such that that power may be regenerated when the vehicle 308 is coasting on relatively level terrain and/or traveling downhill. In some embodiments, the one or more motors 390a-390d may be placed in a front of the vehicle 308 such that the power regeneration is enhanced. For example, the one or more motors 390a-390d may be placed in the front of the vehicle 308 such that a weight bias towards the front of the vehicle 308 during braking and/or deceleration enhances the power regeneration. In some embodiments, the location and/or configuration of the one or more centerless brake assemblies 360 in the vehicle 308 may permit a higher ratio of power generation than the location and/or configuration of conventional brake systems on conventional vehicles.

In these and other embodiments, the kinetic energy of deceleration of the surrounding vehicle mass (or resisting acceleration down a hill) may be stored chemically in batteries or electricity storage systems as the vehicle 308 slows down. Additionally or alternatively, the kinetic energy of deceleration may be stored mechanically in a flywheel. In these and other embodiments, the stored energy may be drawn from the batteries and/or the flywheel such that the energy recouped during deceleration can be conversely applied to the same device for assist with acceleration.

Modifications, additions, or omissions may be made to the vehicle 308 of FIG. 6 without departing from the scope of the present disclosure. For example, the various views and example implementations of the vehicle are merely examples and other iterations and potential combinations of operations of the motors 390 are contemplated within the scope of the present disclosure.

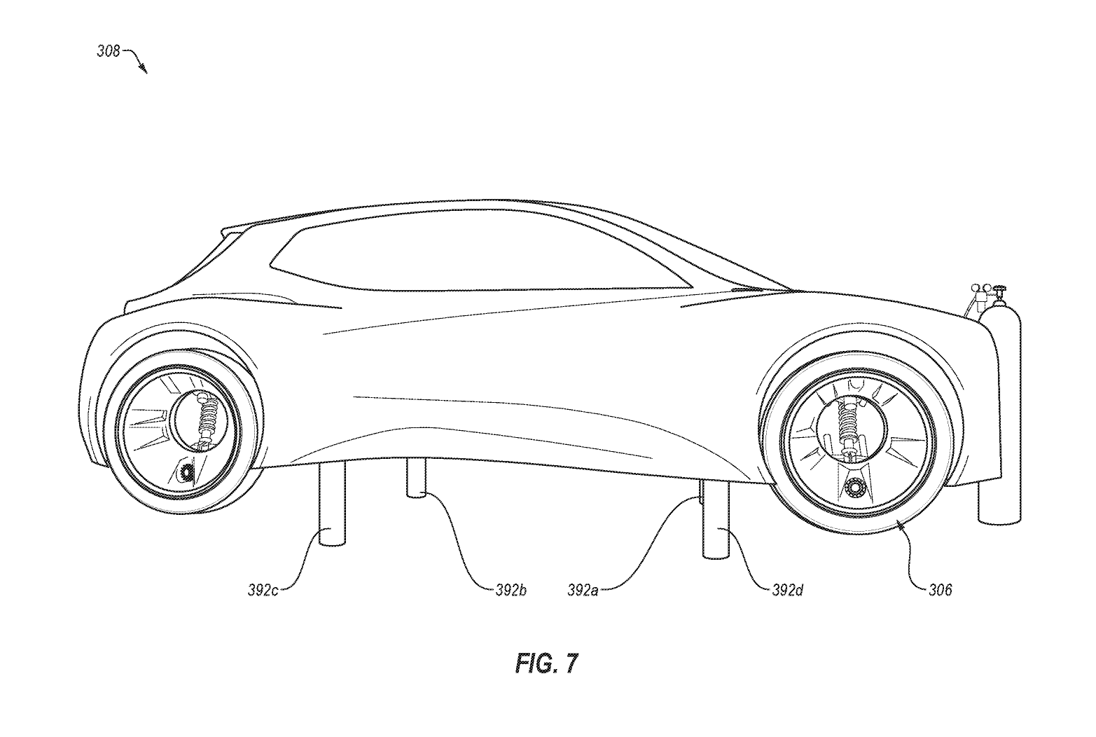

FIG. 7 illustrates an embodiment of the vehicle 308 with one or more lifts 392a-392d, in accordance with one or more embodiments of the present disclosure. The vehicle 308 may include the one or more lifts 392a-392d. The one or more lifts 392a-392d may be used to raise and/or lower a portion of vehicle 308 and/or the entire vehicle 308. In some embodiments, the one or more lifts 392a-392d may facilitate accessibility to the one or more centerless wheel assemblies 306, one or more centerless brake assemblies 360, one or more suspension assemblies 380, one or more motors 390, and/or other assemblies or components of the vehicle 308. For example, the one or more lifts 392a-392d may be used to raise the vehicle 308 such that the one or more centerless wheel assemblies 306 and/or other assemblies or components may be replaced and/or serviced. The one or more lifts 392a-392d may be hydraulic lifts, mechanicals lifts, or any other type of lift. In some embodiments, the one or more lifts 392a-392d may be powered by the one or more motors 390 and/or other assembly and/or component. In some embodiments, the one or more lifts 392a-392d may be extended and/or retracted in unison. Additionally and/or alternatively, the one or more lifts 392a-392d may be extended and/or retracted in pairs. Additionally and/or alternatively, the one or more lifts 392a-392d may be extended and/or retracted individually.

The one or more centerless wheel assemblies 306 may be configured such that the one or more centerless wheel assemblies 306 may be easily coupled with and/or removed from the vehicle 308. For example, as illustrated in FIG. 7, the one or more centerless wheel assemblies 306 may be coupled with the vehicle 308 via a nut (such as the 354 as illustrated in FIG. 5), facilitating the removal and/or replacement of the one or more centerless wheel assemblies 306 in a number of seconds.

Modifications, additions, or omissions may be made to the vehicle 308 of FIG. 7 without departing from the scope of the present disclosure. For example, any of the features and/or principles described with reference to other embodiments of the present disclosure may be applied to the vehicle 308 illustrated in FIG. 7.

FIG. 8A illustrates an embodiment of the one or more centerless brake assemblies 360 and the one or more suspension assemblies 380. The one or more centerless brake assemblies 360 may be coupled to the stationary hub 310. The one or more centerless brake assemblies 360 may also be coupled to the one or more suspension assemblies 380. The one or more centerless brake assemblies 360 may interface with the centerless rim 330.

The one or more centerless brake assemblies 360 may include a centerless rotor 362 and a brake caliper 364. The one or more brake assemblies 360 may have a familiar structure and/or function to conventional disc brakes. In some embodiments, the one or more brake assemblies may have a different structure and/or function than conventional disc brakes. The one or more centerless brake assemblies 360 may be configured such that the brake caliper 364 may contact and slow the centerless rim 330.

In some embodiments, the one or more centerless brake assemblies 360 may require less force to slow the centerless rim 330 and/or the vehicle 308 than conventional brake assemblies. In some embodiments, the one or more centerless brake assemblies 360 may operate at a lower temperature than conventional brake assemblies. For example, the one or more centerless brake assemblies 360 may operate at a lower temperature than conventional brake assemblies because the one or more centerless wheel assemblies 306 may be lighter than conventional wheel and axle assemblies.

As illustrated in FIG. 8B, in some embodiments, the one or more centerless brake assemblies 360 may allow for aerodynamically directed airflow such that the one or more centerless brake assemblies 360 remain at a cooler temperature during operation. In some embodiments, the centerless nature of the one or more centerless wheel assemblies 306 may facilitate the aerodynamically directed airflow to the one or more centerless brake assemblies 360.

In some embodiments, the brake caliper 364 may be located at a point approximately equidistant between the ground and the top of the centerless wheel assembly 306. In these and other embodiments, the brake caliper 364 may be located on a leading edge of the centerless wheel assembly 306, or in other words, in a direction of forward travel for the vehicle 308.

The one or more suspension assemblies 380 may include a device or component that may be used to dampen the forces that may be encountered by the centerless wheel assembly 306 during use of the vehicle 308. In some embodiments, as illustrated in FIG. 8A, the one or more suspension assemblies 380 may be coupled to the back portion of the one or more brake assemblies 360.

As illustrated in FIGS. 8C and 8D, in some embodiments, the one or more centerless wheel assemblies 306 may be configured such that the empty space in the center portion of the one or more centerless wheel assemblies 306 may contain one or more devices, components, and/or instruments including such as an odometer 366 and/or one or more other sensors 368. In some embodiments the odometer 366 and the one or more sensors 368 may be in communication with each other, a computing device associated with the vehicle 308, or any other component. Additionally or alternatively, the odometer 366 and/or the one or more sensors 368 may be coupled to a computing system located within the vehicle 308.

In these and other embodiments, the one or more centerless wheel assemblies 306 may be coupled with the odometer 366. In some embodiments, the odometer 366 may be used to measure the directional velocity and/or angular velocity of the one or more centerless wheel assemblies 306 and/or the vehicle 308. Additionally and/or alternatively, as illustrated in FIG. 8C, the one or more centerless wheel assemblies 306 may be coupled with one or more sensors 368. In some embodiments, the one or more sensors 368 may be used to increase the safety of the vehicle 308. For example, as illustrated in FIG. 8D, the one or more sensors 368 may be used to sense objects including, but not limited to, lanes, curbs, vehicles, and/or other objects. In some embodiments, for example, the one or more sensors 368 may be placed on the portion of the one or more centerless wheel assemblies 306 that is close to the ground such that the vehicle 308 can more easily sense curbs and other low-lying objects compared with conventional sensor devices on other vehicles. In addition, the configuration of the odometer 366 and the one or more sensors 368 may enable accurate measurement of the orientation of the centerless wheel assemblies 306 through the comparison of odometer 366 and sensor 368 input. In some embodiments, the odometer 366 and the one or more sensors 368 may be coupled with a computing system of the vehicle 308 such that the computing system may detect dangerous driving conditions including, but not limited to, slippage and/or sliding of the one or more centerless wheel assemblies 306. For example, in some embodiments, the computer system may provide corrective acceleration and/or deceleration of the centerless wheel assemblies 306 to prevent slippage. Additionally and/or alternatively, the computer system may detect dangerous driving conditions and may provide corrective steering.

Modifications, additions, or omissions may be made to the centerless wheel assembly 306 and/or vehicle 308 of FIGS. 8A-8D without departing from the scope of the present disclosure. For example, any of the features and/or principles described with reference to other embodiments of the present disclosure may be applied to centerless wheel assembly 306 and/or vehicle 308 of FIGS. 8A-8D.

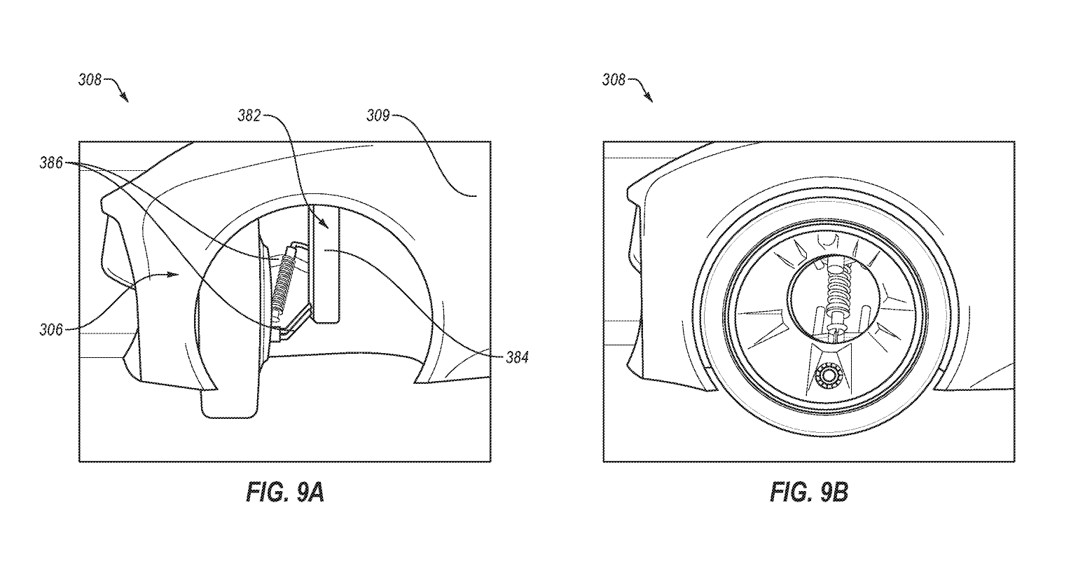

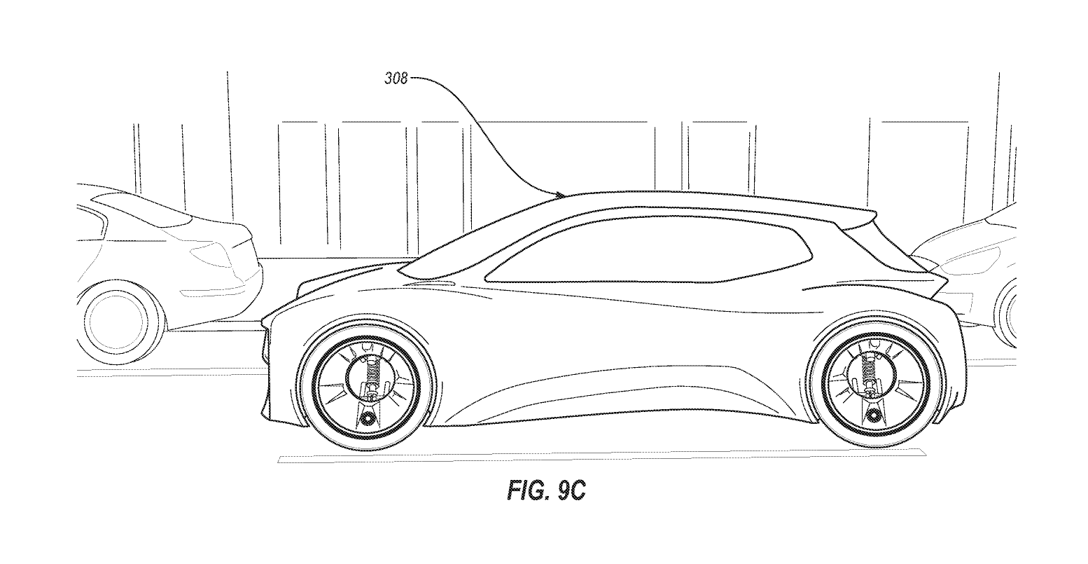

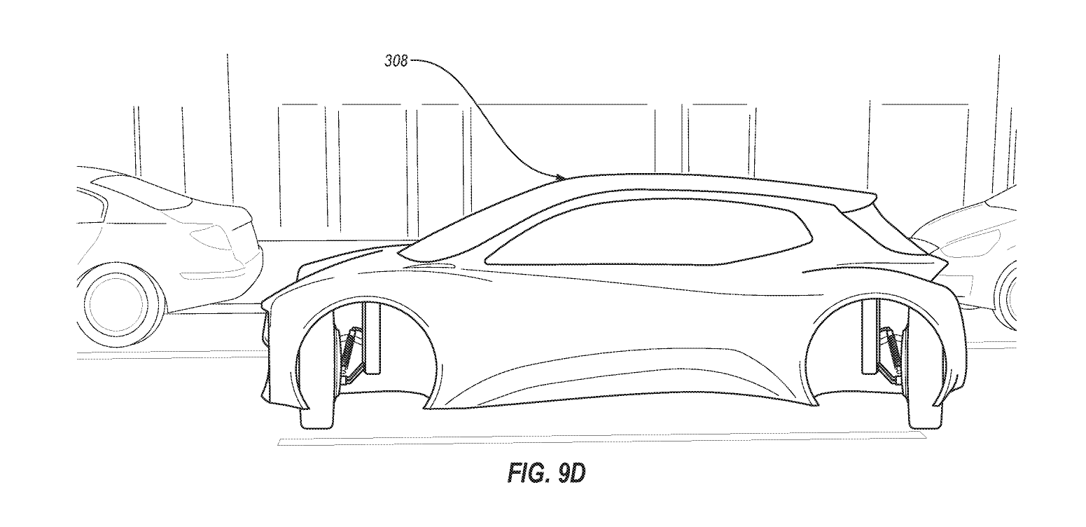

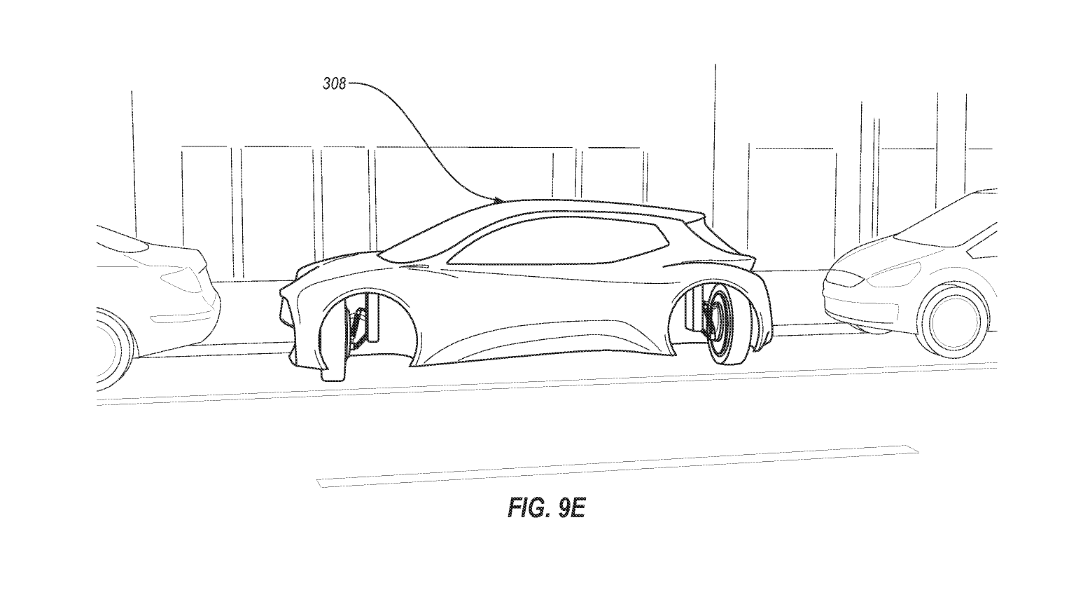

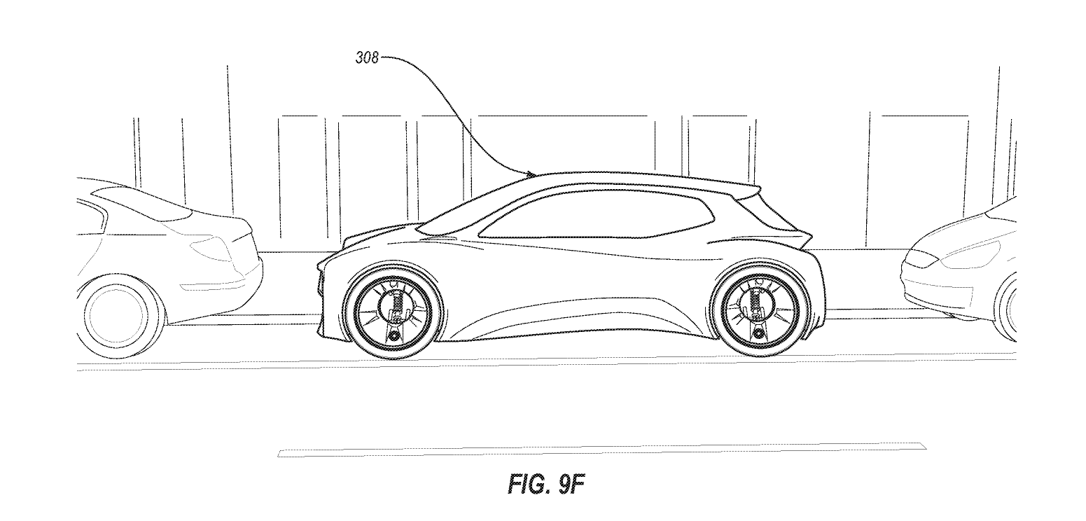

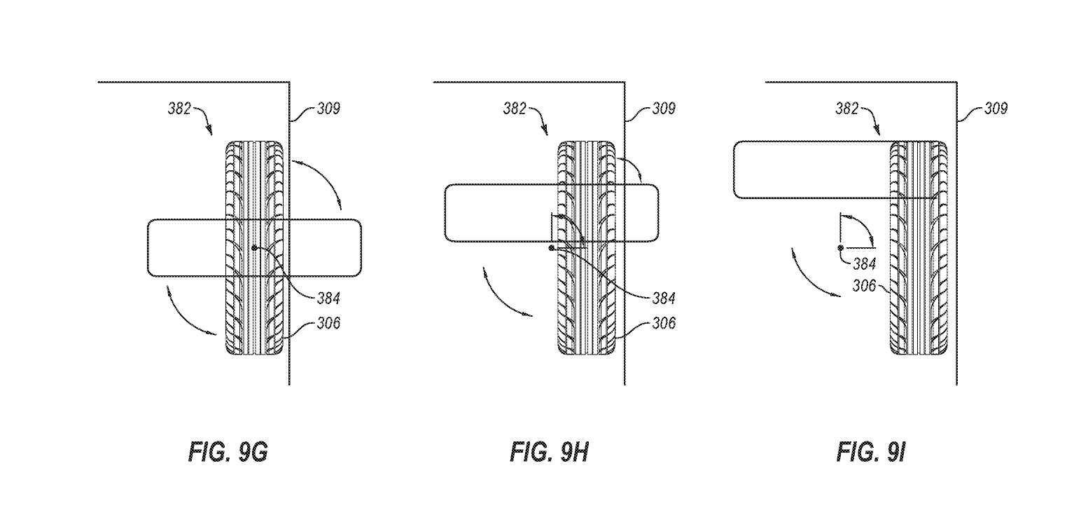

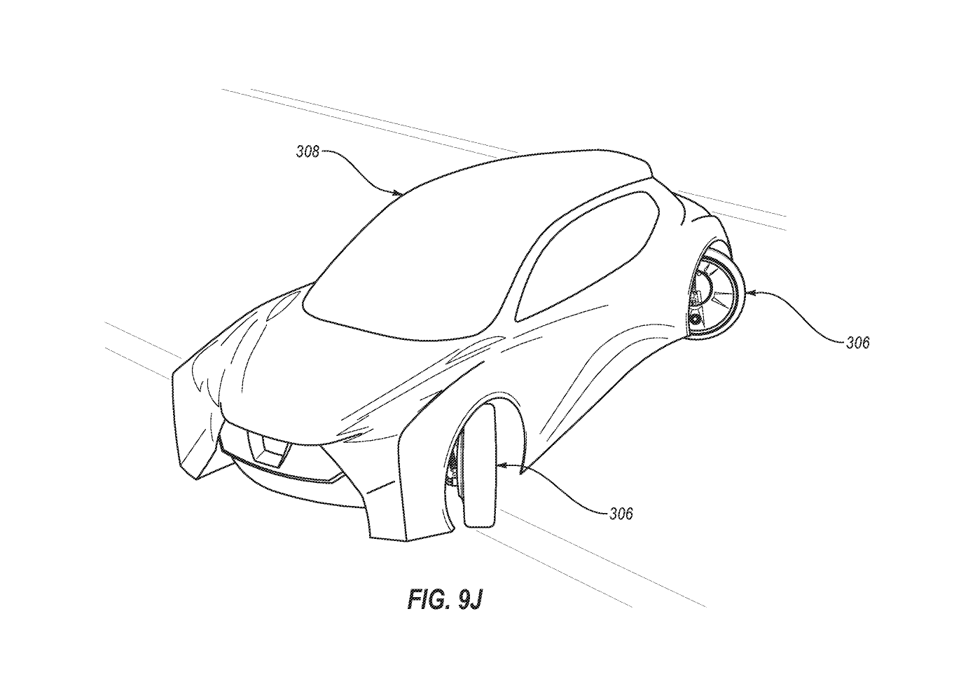

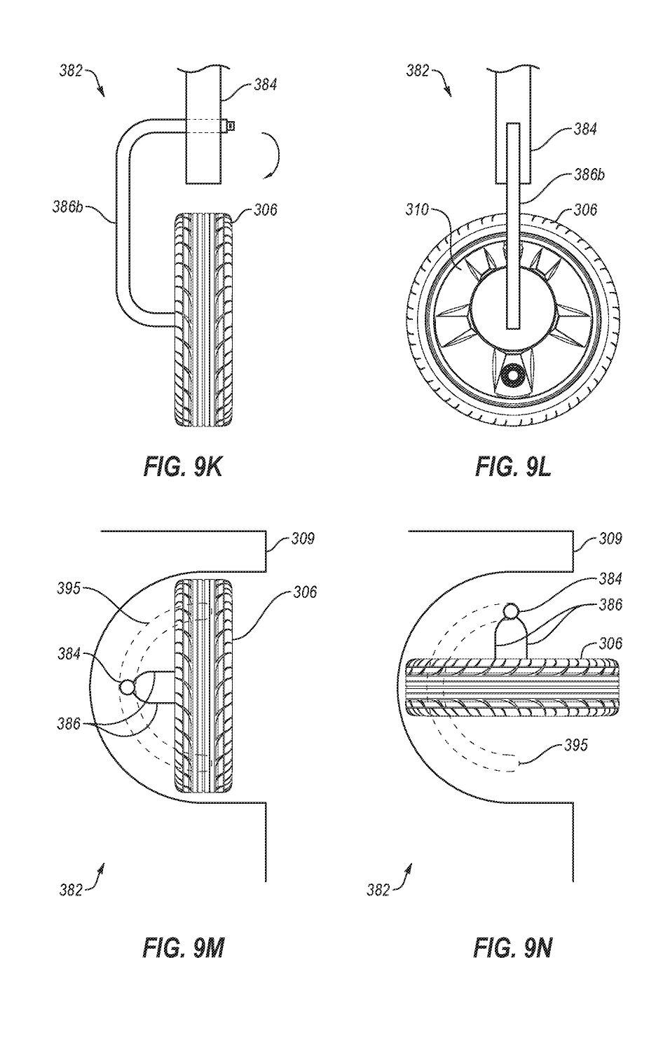

FIGS. 9A and 9B illustrate an embodiment of a turning mechanism 382 of the vehicle 308. The turning mechanism 382 may include a vertical axle 384 and one or more support rods 386. The vertical axle 384 may be coupled with the vehicle 308. For example, in some embodiments, the vertical axle 384 may be rotatably coupled with the vehicle 308 via a chassis of the vehicle 308. The vertical axle 384 may be coupled to the one or more centerless wheel assemblies 306 via the one or more support rods 386.

The turning mechanism 382 may include a device or component that may be used to pivot the one or more centerless wheel assemblies 306 around an axis created by the vertical axle 384. For example, a servo motor or other motor may be coupled to the vertical axle 384 to rotate the vertical axle about a vertical axis of rotation through the axle. As another example, a pneumatic or other pressurized device may be coupled to the vertical axle 384 to facilitate the rotation of the vertical axle 384. The turning mechanism 382 may function similarly to and/or differently from a rack and pinion steering mechanisms found in conventional vehicles. In some embodiments, the turning mechanism 382, when coupled with the vertical axle 384 and/or the one or more centerless wheel assemblies 306, may utilize more space around the one or more centerless wheel assemblies 306 than is utilized to turn a wheel in a conventional steering system. Additionally and/or alternatively, the turning mechanism 382, when coupled with the vertical axle 384 and/or the one or more centerless wheel assemblies 306, may utilize less space around the one or more centerless wheel assemblies 306 than is utilized to turn a wheel in a conventional steering system. The turning mechanism 382 may be coupled with the vehicle 308 such that the turning mechanism 382 may pivot three hundred and sixty degrees about the axis created by the vertical axle 384. In some embodiments, the turning mechanism 382 may allow a steering method in which the turning mechanism 382 may pivot between minus ninety degrees (as illustrated in FIG. 9A) and ninety degrees with zero degrees being the point where the one or more centerless wheel assemblies 306 may be substantially parallel to the plane created by a body 309 of the vehicle 308, e.g., so the centerless wheel assembly 306 is driving the vehicle 308 straight forward (as illustrated in FIG. 9B). In some embodiments, the turning mechanism 382 may facilitate turning the centerless wheel assemblies through various ranges of rotation, including a full three hundred and sixty degrees relative to the vehicle 308, at least two hundred and seventy degrees relative to the vehicle 308 (e.g., negative one hundred and thirty five to one hundred and thirty five degrees), at least two hundred and forty degrees relative to the vehicle 308 (e.g., negative one hundred and twenty to one hundred and twenty degrees), at least two hundred and twenty degrees relative to the vehicle 308 (e.g., negative one hundred and ten to one hundred and ten degrees), at least two hundred degrees relative to the vehicle 308 (e.g., negative one hundred to one hundred degrees), at least one hundred and eighty degrees relative to the vehicle 308 (e.g., negative ninety to ninety degrees), at least one hundred and seventy degrees relative to the vehicle 308 (e.g., negative eighty five to eighty five degrees), at least one hundred and sixty degrees relative to the vehicle 308 (e.g., negative eighty to eighty degrees), at least one hundred and fifty degrees relative to the vehicle 308 (e.g., negative seventy five to seventy five degrees), at least one hundred and forty degrees relative to the vehicle 308 (e.g., negative seventy to seventy degrees), etc.

FIGS. 9C-9F illustrate an example steering method that the vehicle 308 may use to maneuver the car to the side in either direction such that the vehicle 308 may move directly sideways. In some embodiments, the steering method may allow the face of the one or more centerless wheel assemblies 306 to be substantially parallel to the plane created by the body 309 of the vehicle 308, allowing the vehicle 308 to travel in a forward direction, or zero degrees, as illustrated in FIGS. 9C and 9F. Additionally and/or alternatively, the steering method may allow one or more centerless wheel assemblies 306 to pivot such that the vehicle may “crab crawl” and/or travel in a direction ninety degrees from the forward direction, or zero degrees, as illustrated in FIG. 9D and FIG. 9E, or any angle in between. In some embodiments, the steering method may be used to assist the driver with parallel parking of the vehicle 308. For example, as illustrated in FIGS. 9C-9F, the steering method may allow the vehicle 308 to parallel park by allowing the vehicle 308 to move directly into an open parking space while requiring minimal space in front of and/or behind the vehicle 308. In some embodiments, the vehicle 308 may be configured such that the vehicle 308 may park without assistance from a driver.

FIGS. 9G-9I illustrate a vertical view of several embodiments of the turning mechanism 382. The vertical axle 384 may be coupled with the one or more centerless wheel assemblies 306 at a location within and/or above a footprint created by the one or more centerless wheel assemblies 306, as illustrated in FIG. 9H. In some embodiments, the vertical axle 384 may be coupled with the one or more centerless wheel assemblies 306 such that the one or more centerless wheel assemblies 306 may pivot around the center of the one or more centerless wheel assemblies 306 between an angles of zero degrees and ninety degrees, with zero degrees being the point where the one or more centerless wheel assemblies 306 may be substantially parallel to the plane created by a body 309 of the vehicle 308. As illustrated in FIG. 9G, the space that may be utilized to pivot the one or more centerless wheel assemblies 306 may be substantially equal to a sphere of space created by rotating a diameter of the one or more centerless wheel assemblies 306.

The vertical axle 384 may be coupled with the one or more centerless wheel assemblies 306 at a location outside of and/or at a short distance from the footprint created by the one or more centerless wheel assemblies 306, as illustrated in FIG. 9H. In some embodiments, the vertical axle 384 may be coupled with the one or more centerless wheel assemblies 306 such that the one or more centerless wheel assemblies 306 may pivot around the vertical axle 384 between angles of zero degrees and ninety degrees, with zero degrees being the point where the one or more centerless wheel assemblies 306 may be substantially parallel to the plane created by a body 309 of the vehicle 308. As illustrated in FIG. 9H, the space that may be utilized to pivot the one or more centerless wheel assemblies 306 may be greater than the sphere of space created by rotating a diameter of the one or more centerless wheel assemblies 306.

The vertical axle 384 may be coupled with the one or more centerless wheel assemblies 306 at a location outside of and/or at a larger distance than the embodiment of FIG. 9H from the footprint created by the one or more centerless wheel assemblies 306, as illustrated in FIG. 9I. Additionally and/or alternatively, the vertical axle 384 may be coupled with the one or more centerless wheel assemblies 306 such that the one or more centerless wheel assemblies 306 may pivot around the vertical axle 384 between angles of zero degrees and ninety degrees, with zero degrees being the point where the one or more centerless wheel assemblies 306 may be substantially parallel to the plane created by a body 309 of the vehicle 308. As illustrated in FIG. 9I, the space that may be utilized to pivot the one or more centerless wheel assemblies 306 may be greater than the sphere of space created by rotating a diameter of the one or more centerless wheel assemblies 306.

FIG. 9J illustrate an embodiment of the vehicle 308 utilizing the turning mechanism 382 illustrated in FIGS. 9A-9I. The vehicle 308 may have the capabilities of four-wheel drive and/or four-wheel steering. The turning mechanism 382 may allow each of the four centerless wheel assemblies 306 to assist with the steering and/or turning of the vehicle 308, as illustrated in FIG. 9J. For example, as illustrated in FIG. 9J, the vehicle 308 may use four-wheel steering to make tight turns. In these and other embodiments, the vehicle 308 may use four-wheel steering to make tighter turns than those that can be made by a conventional vehicle. In some embodiments, the vehicle 308 may use the turning mechanism 382 to turn all four of the one or more centerless wheel assemblies 306 in a coordinated manner. For example the front inside wheel of the turn may be turned at forty five degrees, the rear inside wheel of the turn may be turned at minus forty five degrees, the front outside wheel of the turn may be turned at fifty degrees, and the rear outside wheel of the turn may be turned at minus fifty degrees. In some embodiments, the turning angles of the centerless wheels 306 may be coupled with a steering mechanism of an operator of the vehicle 308 such that the vehicle 308 may respond in a similar or comparable manner to conventional vehicles, but with even sharper turning capabilities.

In some embodiments, the inside wheels of a turn may be at a sharper angle than the outside wheels of the turn to lessen the amount of rubbing experienced by the tires as the vehicle 308 turns sharply.

In some embodiments, the one or more centerless wheel assemblies 306a-306d, may rotate at an angle of slightly less than ninety degrees (e.g., between seventy five and ninety degrees, or between negative sixty and negative ninety degrees), with zero degrees being the point where the one or more centerless wheel 3 assemblies 306 may be substantially parallel to the plane created by a body 309 of the vehicle 308, allowing the vehicle to drive in a three-hundred and sixty degree circle without moving outside a sphere of space created by rotating a length slightly longer than the length of the vehicle 308. Stated another way, each of the centerless wheel assemblies 306a-306d may be rotated until they lie approximately on the circumference of an imaginary circle created by the circular shape that includes each of the points where the centerless wheel assemblies 306a-306d touches the ground. For example, the front left centerless wheel assembly 306 may be turned approximately eighty degrees, the front right centerless wheel assembly 306 may be turned approximately negative eighty degrees, the rear left centerless wheel assembly 306 may be turned approximately negative eighty degrees, and the rear right centerless wheel assembly 306 may be turned approximately eighty degrees.

FIGS. 9K-9N illustrate various other embodiments of the example turning mechanism 382, in accordance with one or more embodiments of the present disclosure. For example, FIGS. 9K-9N illustrate turning mechanisms in which the axis of rotation is about the center of the centerless wheel assembly 306, such as illustrated in FIG. 9G. FIGS. 9K and 9L illustrate a front view and a side view, respectively, of a turning mechanism 382 that uses a support arm 386b. FIGS. 9M and 9N illustrate a top view of a turning mechanism 382 that utilizes a track, channel, etc. to guide movement of the vertical axle 384 to turn the centerless wheel assembly 306.

As illustrated in FIGS. 9K and 9L, in some embodiments, the turning mechanism may include the vertical axle 384 configured to rotate to cause a corresponding rotation of the centerless wheel assembly 306 when steering the vehicle 300. In these and other embodiments, the centerless wheel assembly 306 may be disposed directly below the vertical axle 384. For example, as illustrated in FIG. 9G, the vertical axle 384 may be disposed approximately in the middle of the centerless wheel assembly 306 when viewed from the top down.

The support arm 386b may be configured to couple the vertical axle 384 to the centerless wheel assembly 306. In some embodiments, the support arm 386b may be shaped and configured to span from the vertical axle 384, around the tire of the centerless wheel assembly 306, and into a middle portion of the centerless wheel assembly where the support arm 386b may couple to the stationary hub 310 of the centerless wheel assembly 306. The support arm 386b may take any shape, including a curved profile (e.g., a U-shaped profile), an angled profile (e.g., a V shaped profile), or some combination of straight and curved portions. Using such an arrangement, by rotating the vertical axle as described herein (e.g., with a servo motor, hydraulics, etc.), the centerless wheel assembly 306 may be rotated in any direction, including three hundred and sixty degrees. In such an arrangement, the amount of rotation available to the centerless wheel assembly 306 may be determined by the amount of rotation available to the vertical axle 384.

As illustrated in FIGS. 9M and 9N, in some embodiments the vertical axle 384 may be movable about the centerless wheel assembly 306, rather than merely rotating as illustrated in FIGS. 9K and 9L. For example, the axis of rotation may be in the middle of the centerless wheel assembly 306 (such as is illustrated in FIG. 9G), and the vertical axle 384 may orbit the centerless wheel assembly 306 as the centerless wheel assembly 306 is turned. For example, the vertical axle 384 may be disposed in a track 395 or some other feature or component to guide the motion of the vertical axle 384. The centerless wheel assembly 306 may be fixedly coupled to the vertical axle 384 via support rods 386 such that as the vertical axle 384 is moved, the centerless wheel assembly 306 undergoes a corresponding movement. The track 395 may be positioned and shaped with a curvature and length of support rods 386 such that the axis of rotation remains in the middle of the centerless wheel assembly 306 as the vertical axle 384 is moved. For example, the distance spanned by the support rods 386 between the vertical axle 384 and the centerless wheel assembly 306 may be approximately the radius of the curvature of the track 395.

In some embodiments, such as illustrated in FIGS. 9M and 9L, the centerless wheel assembly 306 may be configured to rotate from negative ninety to ninety degrees with zero degrees being the point where the centerless wheel assembly 306 may be substantially parallel to the plane created by the body 309 of the vehicle 308. Additionally or alternatively, the track 395 may extend further than the half-circle shape. In these and other embodiments, the amount of rotation permitted for the centerless wheel assembly 306 may be based on the length of the track 395.

In some embodiments, a motor or other device may control the motion of the vertical axle 384 through the arcuate path illustrated by the track 395 rather than using an actual track 395. For example, a servo motor or other motor may be used to control the motion of the vertical axle 384 as it rotates about the centerless wheel assembly 306. In these and other embodiments, the motor or other device may or may not use a track.

Modifications, additions, or omissions may be made to the vehicle 308 utilizing the turning mechanism 382 of FIGS. 9A-9N without departing from the scope of the present disclosure. For example, the various views and example implementations of the vehicle 308 and/or turning mechanism 382 are merely examples and other iterations and potential uses of the turning mechanism 382 are contemplated within the scope of the present disclosure.

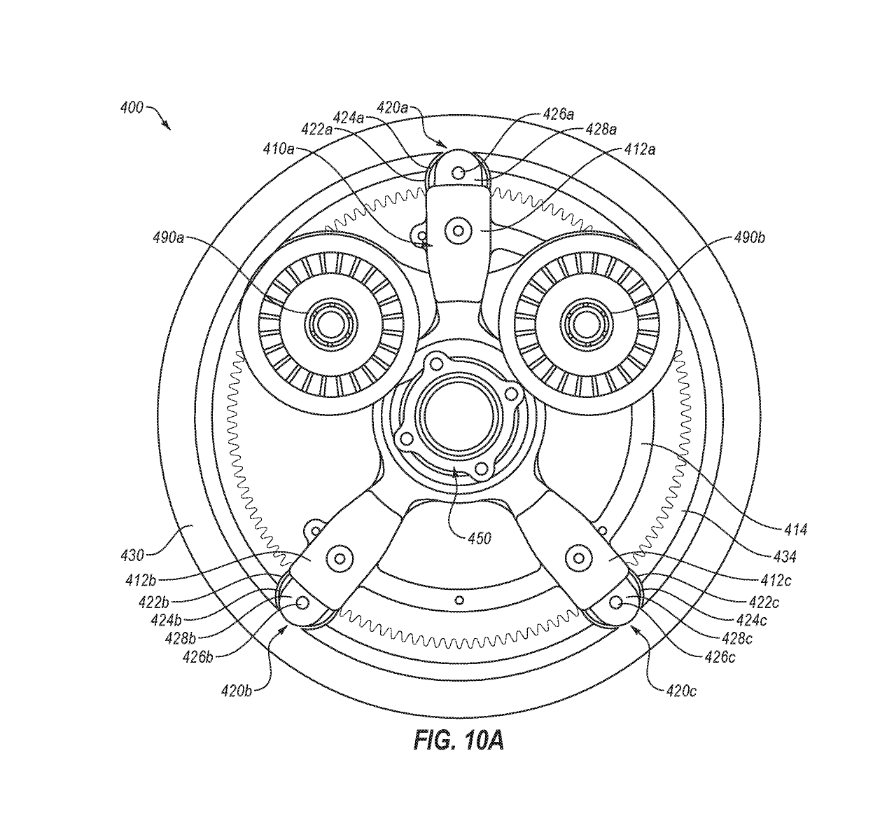

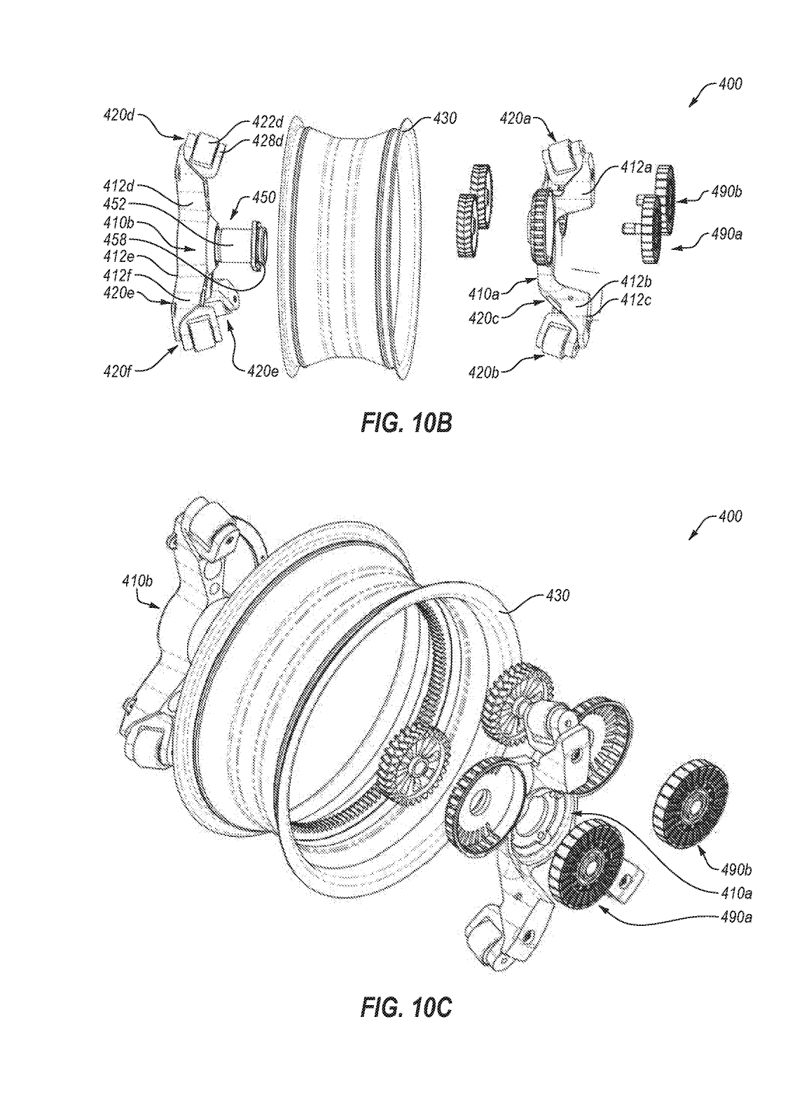

FIGS. 10A-10C illustrate various views of another example centerless rim assembly 400, in accordance with one or more embodiments of the present disclosure. As illustrated in FIGS. 10A-10C, the centerless rim assembly 400 may utilize multiple motors 490 to drive the centerless rim assembly 400. The centerless rim assembly 400 may include one or more stationary hubs 410a-410b, one or more arms 412a-412f, a mounting bracket 414, one or more roller guide assemblies 420a-420f, a centerless rim 430, a gear 434, an axle assembly 450, and one or more motors 490a-490b. The one or more stationary hubs 410a-410b may interface with the one or more roller guide assemblies 420a-420f. The one or more stationary hubs 410a-410b may also interface with the axle assembly 450. The one or more roller guide assemblies 420a-420f may be configured to interface with and roll along the centerless rim 430. The one or more motors 490a-490b may be configured to interface with the gear 434. The mounting bracket 414 may be configured to couple to the one or more arms 412a-412c. In some embodiments, the centerless rim assembly 400 may be configured to interface with a suspension assembly, hub assembly, and/or other component of a vehicle.

One or more of the components of the centerless rim assembly 400 may be similar or comparable to the commonly named components of other Figures of the present disclosure. For example, one or more stationary hubs 410a-410b, the one or more roller guide assemblies 420a-420f, and the centerless rim 430 of FIGS. 10A-10C may be similar or comparable to the stationary hub 110, the one or more roller guide assemblies 120a-120c, and the centerless rim 130 of FIGS. 1, 2, and/or 3, respectively. In addition, the one or more arms 412a-412f and the gear 434 of FIGS. 10A-10C may be similar or comparable to the one or more arms 112a-112c and the gear 134 of FIG. 1. Additionally, the one or more motors 490a-490b of FIGS. 10A-10C may be similar or comparable to the one or more motors 390a-390d of FIG. 6.

As illustrated in FIGS. 10A-10C, the centerless rim assembly 400 may include one or more different components and/or structures than the centerless wheel assembly 100, the stationary hub assembly 111, and/or the centerless rim assembly 102 of FIGS. 1, 2, and/or 3. For example, the centerless rim assembly 400 may contain a mounting bracket 414 not present in the centerless wheel assembly 100 of FIGS. 1, 2, and/or 3. In addition, the centerless rim assembly 400 may contain one or more motors 490a-490b not present in FIGS. 1, 2, and/or 3.

The one or more stationary hubs 410a-410b may act as a rim, frame, exoskeleton plate, and/or structure for the centerless rim assembly 400. The one or more stationary hubs 410a-410b may be coupled via the axle assembly 450.

The one or more stationary hubs 410a may include any shape or profile. As illustrated in FIG. 10B and FIG. 10C, the one or more stationary hubs 410a may include a center portion with one or more arms 412a-412c attached to the center portion. The center portion may include an empty space which may be circular in shape within which the one or more stationary hubs 410a may interface with the axle assembly 450. In some embodiments, the center portion of the one or more stationary hubs 410a may couple to the axle assembly 150 via an axle connector 152. The front surface of the stationary hub 410a may face away from the centerless rim 430 and may be substantially flat. The back surface of the one or more stationary hubs 410a may face the centerless rim 430. The one or more roller guide assemblies 420a-420c may be coupled with the one or more stationary hubs 410a via the one or more arms 412a-412c. The front surface of the one or more arms 412a-412c may be substantially flat and form a plane. In some embodiments, the one or more roller guide assemblies 420a-420c may be coupled to the one or more stationary hubs 410a at an angle from the plane generally defined by the front surface of the one or more stationary hubs 410a. The center portion of the one or more stationary hubs 410a may be substantially flat and may generally form a plane. In some embodiments, the front face of the inner ring of the one or more stationary hubs 410a may be recessed back from the one or more arms 412a-412c and may be substantially parallel to the plane generally formed by the front surface of the one or more arms 412a-412c.

The one or more stationary hubs 410b may include any shape or profile. As illustrated in FIG. 10A-10C, the one or more stationary hubs 410b may include a center portion with one or more arms 412d-412f attached to the center portion. The center portion may include an empty space which may be circular in shape within which the one or more stationary hubs 410b may interface with the axle assembly 450. In some embodiments, the center portion of the one or more stationary hubs 410b may include threads and may couple to corresponding threads on the axle assembly 450. The front surface of the one or more stationary hubs 410b may face away from the centerless rim 430 and may be substantially flat. The back surface of the one or more stationary hubs 410b may face the centerless rim 430. The one or more roller guide assemblies 420e-420f may be coupled with the one or more stationary hubs 410a via the one or more arms 412d-412f. In some embodiments, the one or more roller guide assemblies 420d-420f may be coupled to the one or more stationary hubs 410b at an angle from a plane generally defined by the front surface of the one or more stationary hubs 410b.

The mounting bracket 414 may include a device or component that may interface and/or couple with the mounting arms 412a-412f and/or the one or more stationary hubs 410a-410b and may be used to couple the centerless rim assembly 400 to a vehicle. In some embodiments, the mounting bracket 414 may couple to the mounting arms 412a-412c and may interface with the mounting arms 412d-412f to provide increased stability for one or more components of the centerless rim assembly 400. In some embodiments, the mounting bracket 414 may be used to provide increased stability for the mounting arms 412a-412f and/or the one or more stationary hubs 410a-410b. In some embodiments, the mounting bracket 414 may allow the orientation and/or location of the mounting arms 412a-412f and/or the one or more roller guides 420a-420f.

The one or more roller guide assemblies 420a-420f may include a device or component that may be configured to be rotatably coupled with the back surface of the one or more stationary hubs 410a-410b and interface with the centerless rim 430. The one or more roller guide assemblies 420a-420c may be coupled with the one or more stationary hubs 410a via the one or more arms 412a-412c. The one or more roller guide assemblies 420d-420f may be coupled with the one or more stationary hubs 410b via the one or more arms 412d-412e.

The one or more roller guide assemblies 420a-420f may include one or more roller guides 422a-422f, one or more sets of bearings 424a-424f, one or more shafts 426a-426f, and one or more bearing housings 428a-428f The one or more roller guides 422a-422f may be coupled with the one or more sets of bearings 424a-424f such that the one or more roller guides 422a-422f may rotate. The one or more roller guides 422a-422f may be coupled with the one or more shafts 426a-426f such that the one or more shafts 426a-426f act as an axle and facilitate rotation of the one or more roller guides 422a-422f about the one or more shafts 426a-426f. The one or more shafts 426a-426f may be coupled with the one or more bearing housings 428a-428f. For example, the one or more shafts 426a-426f may be fixedly coupled with the one or more bearing housings 428a-428f The top face of the one or more bearing housings 428a-428f may be generally parallel with the plane created by the top surface of the one or more arms 412a-412f In some embodiments, the top face of the one or more bearing housings 428a-428f may sit at an angle as compared with the plane created by the top surface of the one or more arms 412a-412f In some embodiments, the ends of the one or more shafts 426a-426f may be generally parallel to the plane created by the top face of the one or more bearing housings 428a-428f.

The one or more roller guides 422a-422f may be shaped to roll along the centerless rim 430 as the centerless rim 430 rotates. In some embodiments, the one or more roller guide assemblies 420a-420c may allow the centerless rim assembly 400 to operate at a lower temperature than the wheel/axle combination of convention wheels.

The one or more sets of bearings 424a-424f may be configured such that the one or more roller guides 422a-422f may swivel and move reactionary to a directional change in force that the centerless rim 430 exerts on the one or more roller guides 422a-422f In some embodiments, the one or more sets of bearings 424a-424f may be allowed to swivel and/or rotate in response to one or more thrust loads placed on the one or more bearings 424a-424f such that the one or more sets of bearings 424a-424f maintain contact with the centerless rim 430 and/or reduce friction between the one or more sets of bearings 424a-424f and the centerless rim 430.

The one or more roller guide assemblies 420a-420f may be configured to float such that the one or more roller guide assemblies 420a-420f may maintain contact with the centerless rim 430 if the centerless rim 430 is jostled and/or comes into contact with another object. The one or more roller guide assemblies 420a-420f may be located at an angle that may be generally parallel with the inner portion of the centerless rim 430.

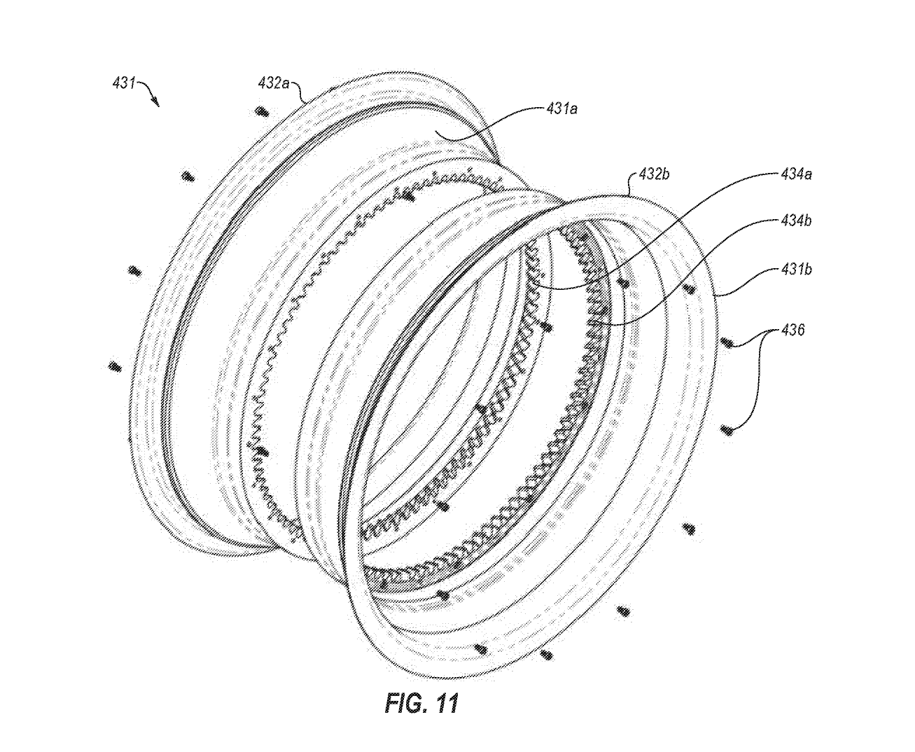

The gear 434 may include a device or component with teeth such that the relationship between the speeds of the centerless rim 430 and the devices and/or components that may drive the centerless rim 430 may be altered. The gear 434 may be formed as part of the inner portion of the centerless rim 430 or may be a separate device and/or component that is coupled with the centerless rim 430. As illustrated in FIG. 11B and FIG. 11C, the gear 434 may be an internal gear and may run parallel to the inner circumference of the centerless rim 430. In some embodiments, the gear 434 may run parallel the centerline of the inner circumference of the centerless rim 430, effectively separating the centerless rim 430 into two equal halves. The gear 434 may include any type of gear including, but not limited to, a herringbone, spur, helical, bevel, and/or worm gear.

The axle assembly 450 may contain an axle connector 452 and an axle coupler 458. The one or more stationary hubs 410a-410b may be coupled together via the axle assembly 450. For example, the one or more stationary hubs 410a may be coupled to a first end of the axle assembly 450 and the one or more stationary hubs 410b may be coupled to a second end of the axle assembly 450 via the axle connector 452 and the axle coupler 458 using fasteners and/or connectors

The axle connector 452 may include any device or component that may be cylindrical in shape and may interface with the axle coupler 458 and the vehicle via the hub, axle, and/or other component of the vehicle. In some embodiments, the axle connector 452 may include a portion that may contain external threads such that the axle connector 452 may be coupled to the vehicle via hub, axle, and/or other component of the vehicle with by a fastener and/or may engage a set of threads that may be located on the hub, axle, and/or other component of the vehicle.

The one or more motors 490a-490b may include a device or component used to interface with and drive the centerless rim 430 via the gears 434. As illustrated in FIGS. 10A-10C, the one or more motors 490a and the one or more motors 490b may couple to the centerless rim 430 via the gears 434 along the upper half of the centerless rim 430 and may be fixedly coupled to the one or more stationary hubs 410a-410b and/or another assembly and/or component of a vehicle. In some embodiments, the one or more motors 490a-490b may couple to the centerless rim 430 via the gears 434 along the lower half and/or other portion of the centerless rim 430. In some embodiments, the one or more motors 490a and the one or more motors 490b may be configured to rotate in the same direction to drive the centerless rim 430. For example, in some embodiments, the one or more motors 490a-490b may be configured to rotate in a clockwise direction and the one or more motors 490b may be configured to rotate in a clockwise direction and may cause a clockwise rotation of the centerless rim 430. The one or more motors 490a-490b may be powered by one or more batteries. In some embodiments, the one or more motors 490a-490b may be powered by one or more batteries that are used to power other assemblies or components of the centerless wheel assembly and/or vehicle.

Modifications, additions, or omissions may be made to the centerless rim assembly 400 of FIGS. 10A-10C without departing from the scope of the present disclosure. For example, any of the features and/or principles described with reference to other embodiments of the present disclosure may be applied to centerless rim assembly 400 of FIGS. 10A-10C.

FIG. 11 illustrates another example centerless rim 431. One or more of the components of the centerless rim 431 may be similar or comparable to the centerless rim 130 of FIGS. 1 and 3, to the centerless rim 230 of FIG. 4, to the centerless rim 330 of FIG. 5, and/or to the centerless rim 430 of FIGS. 10A-10C. For example, gears 434a-434b may be similar to the gear 134 of FIG. 3 and to the gear 434 of FIGS. 10A-10C.

One or more of the components of the centerless rim assembly 400 may be similar or comparable to the commonly named components of FIGS. 1, 2, and/or 3. For example, one or more stationary hubs 410a-410b, the one or more roller guide assemblies 420a-420f, and the centerless rim 430 of FIGS. 10A-10C may be similar or comparable to the stationary hub 110, the one or more roller guide assemblies 120a-120c, and the centerless rim 130 of FIGS. 1, 2, and/or 3, respectively. In addition, the one or more arms 412a-412f and the gear 434 of FIGS. 10A-10C may be similar or comparable to the one or more arms 112a-112c and the gear 134 of FIG. 1. Additionally, the one or more motors 490a-490b of FIGS. 10A-10C may be similar or comparable to the one or more motors 390a-390d of at FIG. 6.

The centerless rim 431 may include two portions, the centerless rim 431a and the centerless rim 431b, as illustrated in FIG. 11. In some embodiments, the centerless rim 431a may be a similar and/or identical and/or mirror image of the centerless rim 431b. The centerless rim 431a may be coupled centerless rim 431b via the one or more fasteners 436. As illustrated in FIG. 11, the barrel of the centerless rim 431 may have a profile that may be generally concave in shape with one or more lip portions 432a-432b. In some embodiments, the one or more lip portions 432a-432b may function to retain a tire on the centerless rim 431. In some embodiments, the centerless rim 431 may contain a gear 434 within the inner circumference of the centerless rim 431.

The gear 434 may be formed as part of the inner portion of the centerless rim 431 or may be a separate device and/or component that is coupled with the centerless rim 430. As illustrated in FIG. 11, the gear 434 may be an internal gear and may run parallel to the inner circumference of the centerless rim 431. In some embodiments, the gear 434 may run parallel the centerline of the inner circumference of the centerless rim 431, effectively separating the centerless rim 431 into two equal halves. The gear 434 may include any type of gear including, but not limited to, a herringbone, spur, helical, bevel, and/or worm gear.

Modifications, additions, or omissions may be made to the centerless rim assembly 431 of FIG. 11 without departing from the scope of the present disclosure. For example, any of the features and/or principles described with reference to other embodiments of the present disclosure may be applied to centerless rim assembly 431 of FIG. 11.

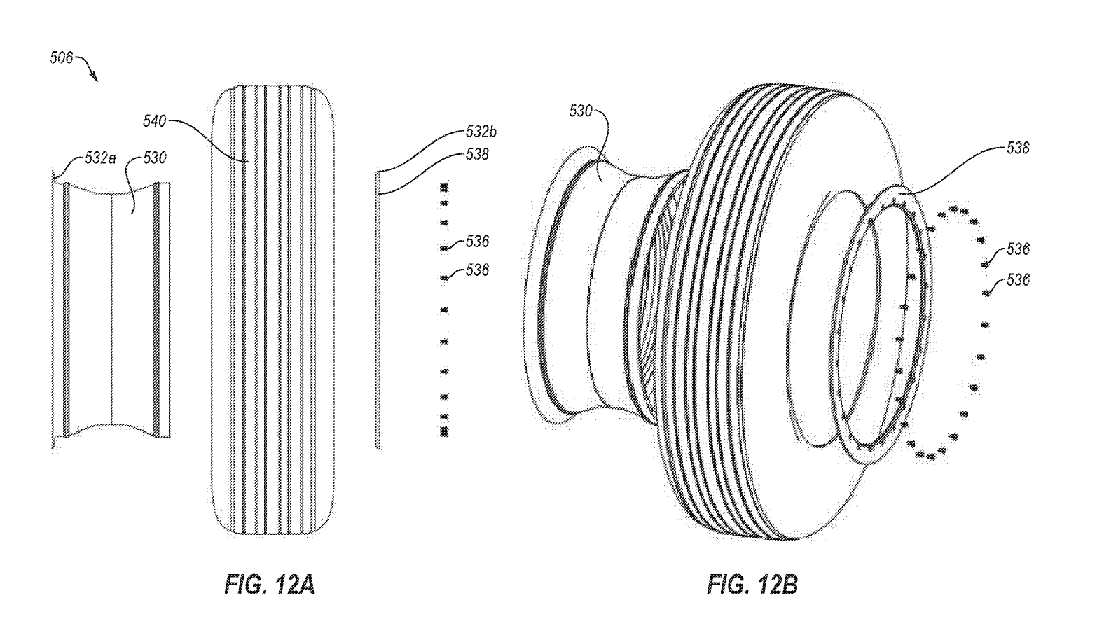

FIGS. 12A and 12B illustrate various views of an embodiment of a centerless wheel assembly 506. FIG. 12A illustrates a front view, exploded view of the centerless wheel assembly 506, and FIG. 12B illustrates a perspective view, exploded view of the centerless wheel assembly 506. The centerless wheel assembly 506 may include a centerless rim assembly 508 and a tire 540. The centerless rim assembly 508 may interface with the tire 540. In some embodiments, the centerless wheel assembly 506 may be utilized in conjunction with a large or heavy vehicle.

One or more of the components of the centerless wheel assembly 506 may be similar or comparable to the commonly named components of FIGS. 1, 2, 3, and/or 11. For example, the centerless rim 530 of FIGS. 12A and 12B may be similar or comparable to the centerless rim 130 of FIGS. 1, 2, and 3, and the centerless rim 431 of FIG. 11, respectively. In addition, for example, the tire 540 may be similar or comparable to the tire 140 of FIG. 1 and the tire 340 of FIGS. 5-7. As illustrated in FIGS. 12A and 12B, the centerless rim 530 may include one or more different components and/or structures than centerless rim 130 of FIGS. 1, 2, and/or 3 and the centerless rim 431 of FIG. 11. For example, the centerless rim 530 may contain a retaining ring 538 that may be detachable from the centerless rim 530 not present in FIGS. 1, 2, 3, and 11.

The centerless rim assembly 508 may be a device or component that may be configured to rotate around an axis defined by the center point of the centerless rim assembly 508 and may be coupled to the tire 540. The centerless rim assembly 508 may include a centerless rim 530, a retaining ring 538, and one or more fasteners 536.

The centerless rim 530 may be sized of a circumference and/or width comparable or similar to any standardized size of wheel used on automobiles, motorcycles, scooters, earth-moving equipment, military vehicle, aircraft, lawn and garden machines, planetary rovers, and/or any other vehicle in general. In some embodiments, the centerless rim 530 may enclose a generally cylindrical shape with two flat faces and one curved face. The centerless rim 530 may be configured to rotate about a line that passes perpendicularly through the two flat faces. The centerless rim 530 may contain a void of material within the centerless rim 530. In some embodiments, the centerless rim 530 may have a profile such that the tire 540 may be coupled to the outer portion of the centerless rim 530. The centerless rim 530 may be configured to be coupled to a vehicle.

As illustrated in FIGS. 12A and 12B, a barrel of the centerless rim 530 may have a profile that may be generally concave in shape with a lip portion 532a. In some embodiments, the lip portion 532a may function to retain the tire 540 tire on the centerless rim 530. In addition, the centerless rim 530 may couple to the retaining ring 538. For example, the centerless rim 530 may couple to the retaining ring 538 via the one or more fasteners 536. In some embodiments, a portion 532b of the retaining ring 538 may act as a lip portion and may function to retain the tire 540 on the centerless rim 530. In some embodiments, the centerless rim 530 may couple to the retaining ring 538 such that the tire 540 may be retained around the circumference of the centerless rim 530. Additionally and/or alternatively, the centerless rim 530 and the tire 540 may be coupled such that the centerless rim 530 and the tire 540 rotate as a single assembly. Additionally and/or alternatively, the centerless rim 530 and the tire 540 may be coupled such that the centerless rim 530 and the tire 540 do not rotate as a single assembly.

In some embodiments, the centerless wheel assembly 506 may be coupled to a vehicle. For example, in some embodiments, the centerless wheel assembly 506 may be configured to interface with a suspension assembly, hub assembly, and/or other component of a vehicle. In some embodiments, the centerless wheel assembly 506 may be configured to be coupled with heavy vehicles. For example, the centerless wheel assembly 506 may be coupled to earth-moving equipment, semi-trucks, aircrafts, trailers, and the like. In some embodiments, the centerless wheel assembly 506 may be coupled to a motor that may drive the centerless wheel assembly 506. Additionally and/or alternatively, the centerless wheel assembly 506 may not be coupled with a motor. For example, the centerless wheel assembly 506 may be configured to rotate without direct input from a motor and/or power source. In addition, the centerless wheel assembly 506 may be coupled with a vehicle and may be configured to rotate with the movement of the vehicle.

Modifications, additions, or omissions may be made to the centerless wheel assembly 506 of FIGS. 12A and 12B without departing from the scope of the present disclosure. For example, any of the features and/or principles described with reference to other embodiments of the present disclosure may be applied to centerless wheel assembly 506 of FIGS. 12A and 12B.

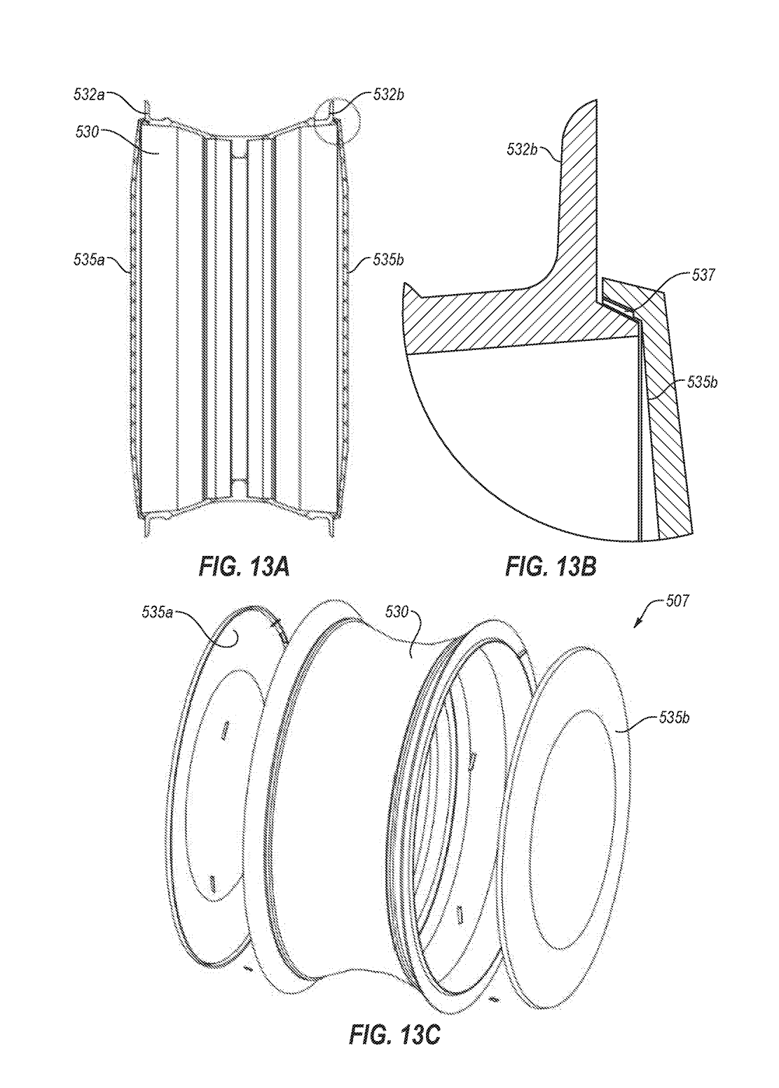

FIGS. 13A-13C illustrates various views of a centerless rim assembly 507. FIG. 13A illustrates a front view of the centerless rim assembly 507, FIG. 13B illustrates another view of a portion of the centerless rim assembly 507, and FIG. 13C illustrates an exploded view of the centerless rim assembly 507. The centerless rim assembly 507 may include a centerless rim 530, one or more centerless rim covers 535a-535b, and one or more patches 537. The centerless rim 530 may be coupled with the one or more centerless rim covers 535a-535b, with the centerless rim cover 535a being coupled to the front side of the centerless rim 530 and with the centerless rim cover 535b being coupled to the back side of the centerless rim 530. The one or more patches 537 may be coupled to the centerless rim 530 and/or the one or more centerless rim covers 535a-535b.

One or more of the components of the stationary rim assembly may be similar or comparable to the commonly named components of at least FIGS. 12A and 12B. For example, the centerless rim assembly 507 of FIGS. 13A-13C may be similar or comparable to the centerless wheel assembly 506 of FIGS. 12A and 12B. In addition, the centerless rim 530 of FIGS. 13A-13C may be similar or comparable to the centerless rim 130 of FIGS. 1, 2, 3, the centerless rim 431 of FIG. 11, and the centerless rim 530 of FIGS. 12A and 12B, respectively. As illustrated in FIGS. 13A-13C, the centerless rim assembly 507 may include one or more different components and/or structures than the centerless wheel assembly 506 of FIGS. 12A and 12B. For example, the centerless rim 530 of FIGS. 13A-13C may be shaped differently than the centerless rim 530 of FIGS. 12A and 12B. In addition, the centerless rim assembly 507 of Figu FIGS. 13A-13C may contain one or more centerless rim covers 535a-535b and one or more patches 537 which are not present in FIGS. 12A and 12B.

The one or more centerless rim covers 535a-535b may include a device or component that may be used to prevent matter from entering into and/or interfering with the operation of the centerless rim assembly 507. The one or more centerless rim covers 535a-535b may be configured to remain stationary as the centerless rim 530 rotates. The one or more centerless rim covers 535a-535b may be any size or shape. In some embodiments, the one or more centerless rim covers 535a-535b may be similar in size and/or shape to the centerless rim 530. As illustrated in FIGS. 13A-13C, the one or more centerless rim covers 535a-535b may be a thin, circular piece of material and may contain an empty space in the center. In some embodiments, the one or more centerless rim covers 535a-535b may couple to a vehicle via the hub, axle, and/or other component of the vehicle. In addition, the one or more centerless rim covers 535a-535b may couple to one or more stationary hub assemblies and/or one or more roller guide assemblies. The one or more centerless rim covers 535a-535b may be coupled with the one or more patches 537.

The one or more patches 537 may include any device or component that may reduce the friction between the components of the centerless rim assembly 507 and/or help guide the path of the centerless rim 530. The one or more patches 537 may be constructed of a low-friction material and/or may include a coating that may reduce the friction created between the centerless rim 530 and the one or more centerless rim covers 535a-535b. The one or more patches 537 may be generally rectangular in shape. In these and other embodiments, the patches 537 may be a point of contact with both the centerless rim 530 and the centerless rim covers 535a-535b such that the centerless rim covers 535a-535b may not actually physically contact the centerless rim 530.

Modifications, additions, or omissions may be made to the centerless rim assembly 507 of FIGS. 13A-13C without departing from the scope of the present disclosure. For example, any of the features and/or principles described with reference to other embodiments of the present disclosure may be applied to centerless rim assembly 507 of FIGS. 13A-13C.

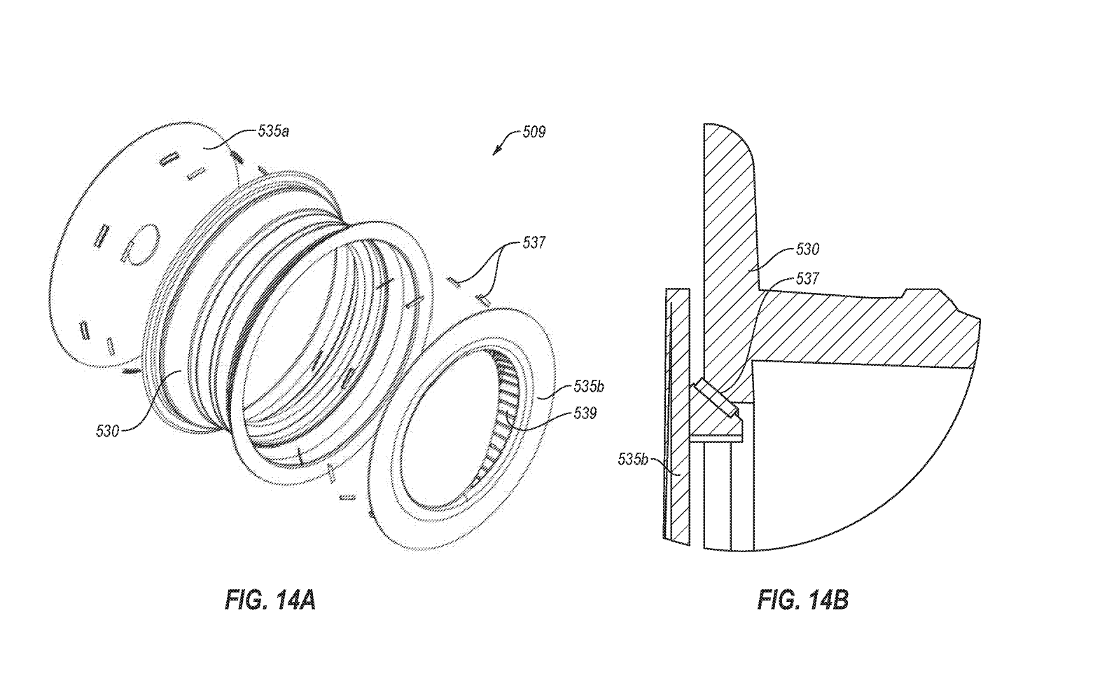

FIGS. 14A and 14B illustrate various views of a centerless rim assembly 509. FIG. 14A illustrates an exploded view of the centerless rim assembly 509, and FIG. 14B illustrates another view of a portion of the centerless rim assembly 509. The centerless rim assembly 509 may include a centerless rim 530, one or more centerless rim covers 535a-535b, and one or more patches 537. The centerless rim 530 may be coupled with the one or more centerless rim covers 535a-535b, with the one or more centerless rim covers 535a being coupled to the front side of the centerless rim 530 and with the one or more centerless rim covers 535b being coupled to the back side of the centerless rim 530. The one or more patches 537 may be coupled to the centerless rim 530 and/or the one or more centerless rim covers 535a-535b.

One or more of the components of the stationary rim assembly may be similar or comparable to the commonly named components of at least FIGS. 13A-13C. For example, the centerless rim assembly 509 of FIGS. 14A and 14B may be similar or comparable to the centerless rim assembly 507 of FIGS. 13A-13C. In addition, the centerless rim 530 of FIGS. 14A and 14B may be similar or comparable to the centerless rim 130 of FIGS. 1, 2, and/or 3, the centerless rim 430 of FIGS. 10A-C, the centerless rim 431 of FIG. 11, the centerless rim 530 of FIGS. 12A and 12B, and the centerless rim 530 of FIGS. 13A-13C, respectively. As illustrated in FIGS. 14A and 14B, the centerless rim assembly 509 may include one or more different components and/or structures than centerless rim assembly 507 of FIGS. 13A-13C. For example, the centerless rim 530 of FIGS. 14A and 14B may be shaped differently than the centerless rim 530 of FIGS. 13A-13C. In addition, the one or more centerless rim covers 535a-535b of FIGS. 14A and 14B may be shaped differently than the one or more centerless rim covers 535a-535b of FIGS. 13A-13C.

The one or more centerless rim covers 535a-535b may include a device or component that may be used to prevent matter from entering into and/or interfering with the operation of the centerless rim assembly 507. The one or more centerless rim covers 535a-535b may be configured to remain stationary as the centerless rim 530 rotates. The one or more centerless rim covers 535a-535b may be any size or shape. In some embodiments, the one or more centerless rim covers 535a-535b may be similar in size and/or shape to the centerless rim 530. As illustrated in FIGS. 14A and 14B, the one or more centerless rim covers 535a-535b may be a thin, circular piece of material and may contain an empty space in the center. In some embodiments, the one or more centerless rim covers 535a-535b may couple to a vehicle via the hub, axle, and/or other component of the vehicle. In addition, the one or more centerless rim covers 535a-535b may couple to one or more stationary hub assemblies and/or one or more roller guide assemblies. The one or more centerless rim covers 535a-535b may be coupled with the one or more patches 537.

The one or more centerless rim covers 535a may be shaped differently than the one or more centerless rim covers 535b. In some embodiments, the empty space in the center of one or more centerless rim covers 535a may be smaller than the empty space in the center of one or more centerless rim covers 535b. In addition, the one or more centerless rim covers 535b may include support material 539.

The support material 539 may include a device and or component that may provide support to the one or more centerless rim covers 535b, may prevent debris from entering into the centerless rim assembly 509, and/or may help guide the path of the centerless rim 530. As illustrated in FIGS. 14A and 14B, the support material may be circular in shape. In some embodiments, the support material 539 may run in a circular arc over a portion of the back side of the one or more centerless rim covers 535b. In some embodiments, the support material may cover the entire one or more centerless rim covers 535b. The support material 539 may extend out perpendicularly from a plane created by the back side of the one or more centerless rim covers 535b.

In these and other embodiments, the patches 537 may be a point of contact with both the centerless rim 530 and the centerless rim covers 535a-535b such that the centerless rim covers 535a-535b may not actually physically contact the centerless rim 530.

Modifications, additions, or omissions may be made to the centerless rim assembly 509 of FIGS. 14A and 14B without departing from the scope of the present disclosure. For example, any of the features and/or principles described with reference to other embodiments of the present disclosure may be applied to centerless rim assembly 509 of FIGS. 14A and 14B.

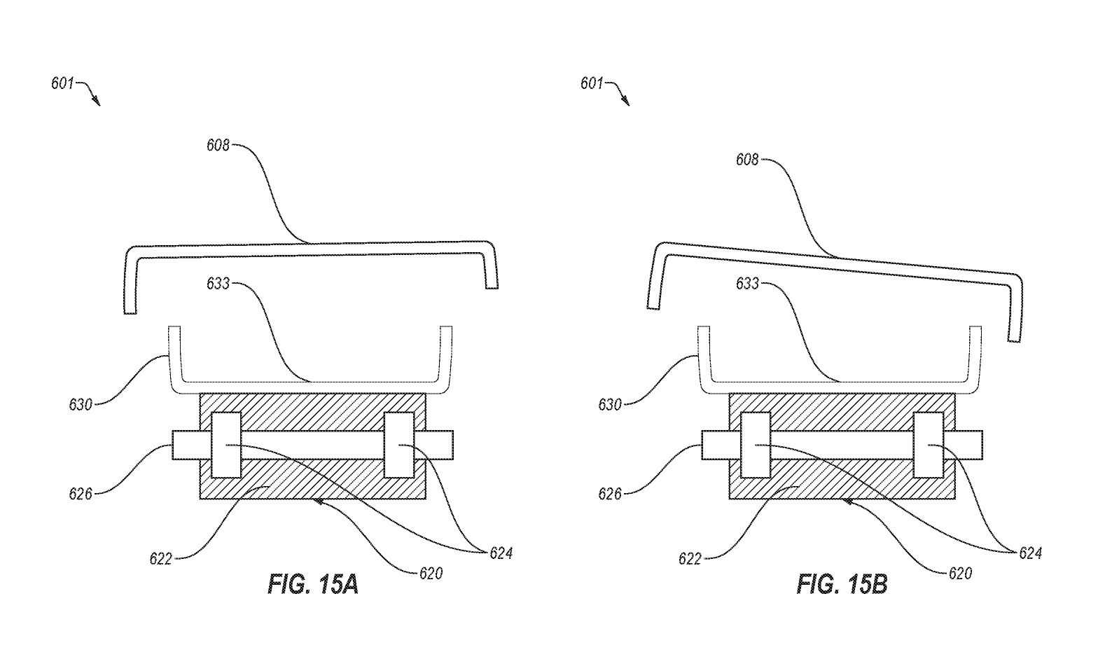

FIGS. 15A and 15B illustrate multiple views of another example centerless rim assembly 601. The centerless rim assembly 601 may include a vehicle 608, a centerless rim 630, and a roller guide assembly 620. The centerless rim 630 may interface with the roller guide assembly 620. The roller guide assembly 620 may include a roller guide 622 and/or one or more bearings 624. The centerless rim 630 may include a portion 633 for interfacing with the roller guide 622. In some embodiments, the portion 633 may be angled and the roller guide 622 may have a corresponding angle. In some embodiments, the centerless rim 630 and/or the roller guide assembly 620 may be substantially parallel to the vehicle 608 (e.g., as illustrated in FIG. 15A). Additionally and/or alternatively, the centerless rim 630 and/or the roller guide assembly 620 may not be substantially parallel to the vehicle 608 (e.g., as illustrated in FIG. 15B).

FIG. 15B illustrates an example centerless rim assembly 601 when the vehicle 608 is turning and/or a face of centerless rim assembly 601 and a face of the roller guide assembly 620 may not be parallel to the vehicle 608. In some embodiments, the centerless rim 630 and the roller guide assembly 620 may interface in such a way that the interaction between the centerless rim 630 and the roller guide assembly 620 may not prematurely wear down the face of the centerless rim 630 and/or the face of the roller guide assembly 620 and/or may not experience scrubbing between the face of the centerless rim 630 and/or the face of the roller guide assembly 620. In some embodiments, a shaft 626 of the roller guide assembly 620 may contain a Heim joint (not shown) on a first and/or a second end of the shaft 626. For example, the Heim joint may be configured such that the centerless rim 630 and the roller guide assembly remain substantially parallel during operation of the vehicle 608.

Modifications, additions, or omissions may be made to the centerless rim assembly 601 of FIG. 15A and FIG. 15B without departing from the scope of the present disclosure. For example, any of the features and/or principles described with reference to other embodiments of the present disclosure may be applied to the centerless rim assembly 601 illustrated in FIGS. 15A and 15B.

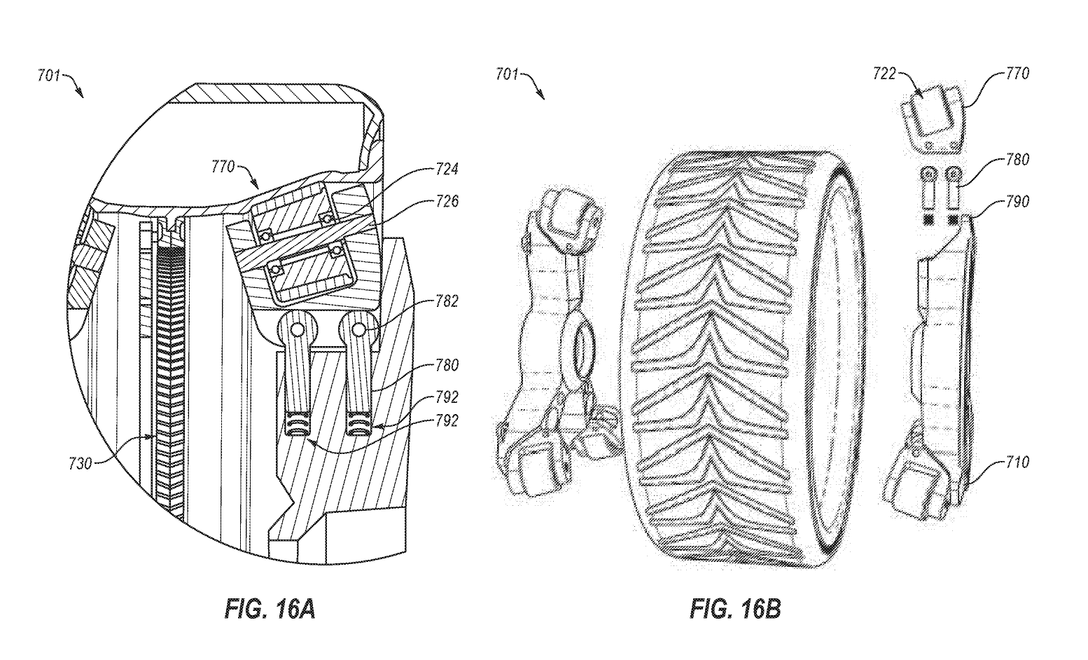

FIGS. 16A and 16B illustrate various views of another example centerless wheel assembly 701, in accordance with one or more embodiments of the present disclosure. The centerless wheel assembly 701 may include additional views and/or detail of a floater assembly 770. The floater assembly 770 may be similar or comparable to the floater assembly 270 of FIG. 4.

As illustrated in FIGS. 16A and 16B, the centerless wheel assembly 701 may be similar or comparable to the other centerless wheel assemblies of the other Figures of the present disclosure. As illustrated in FIGS. 16A and 16B, the floater assembly 770 may be coupled to a stationary hub 710. The stationary hub 710 may be similar or comparable to other similarly named elements within the present disclosure. In these and other embodiments, rather than being directly coupled to the stationary hub 710, the floater assembly 770 may be coupled to the stationary hub 710 via one or more spring arms 780 and springs 790 such that the floater assembly 770 may interface with a centerless rim 730. The centerless rim 730 may be similar or comparable to other similarly named elements within the present disclosure.

In some embodiments, the springs 790 may be coupled to the stationary hub 710 and the spring arms 780. The spring arms 780 may be configured to push against the floater assembly 770 such that the floater assembly 770 remains in contact with the centerless rim 730. In some embodiments, the centerless rim 730 may be non-uniformly circular, such as an ovoid shape, an oval shape, or including other features such that the centerless rim 730 is not perfectly circular. Such shape may be an artifact of a manufacturing process of the centerless rim 730 and/or an artifact of use of the centerless rim 730 over time. In some embodiments, such a shape may be intentional, or may be an undesired aspect of the centerless rim 730 being addressed through the use of the floater assembly 770. For example, as the floater assembly 770 rolls along the centerless rim 730, as the overall radius of the centerless rim 730 decreases, the springs 790 may be compressed, and as the overall radius of the centerless rim 730 increases, the springs 790 may expand via the spring force of the springs 790 to maintain contact between the floater assembly 770 and the centerless rim 730. In some embodiments, one of the springs may be compressed further than the other due to variations in the circularity of the centerless rim 730.

In some embodiments, the floater assembly 770 may include a roller guide 722, one or more bearings 724, and a shaft 726, which may be similar or comparable to similarly named elements described in the other Figures of the present disclosure. In operation, the floater assembly 770 may operate in a similar manner to the other roller guide assemblies, with the difference that the spring arms 780 and/or the springs 790 may facilitate variation in location and/or orientation of the floater assembly 770.

As illustrated in FIGS. 16A and 16B, one or both of the spring arms 780 may press against the floater assembly 770 to affect the orientation and/or location of the floater assembly 770. In these and other embodiments, the variation in orientation and/or location of the floater assembly 770 may maintain contact between the roller guide 722 and the centerless rim 730. Additionally or alternatively, the variation in orientation and/or location of the floater assembly 770 may maintain contact between other roller guides and the centerless rim 730.

In some embodiments, the springs 790 may be disposed within channels 792. The springs 790 may or may not be fixedly coupled to the base of the channels 792. Additionally or alternatively, the springs 790 may or may not be fixedly coupled to the spring arms 780.

In some embodiments, the spring arms 780 may be coupled to the floater assembly 770 via one or more shafts 782. The shafts 782 may span a portion of a casing of the floater assembly 770 such that the shafts 782 may act as pivot points for the spring arms 780. In these and other embodiments, the use of the shafts 782 may maintain the spring arms 780 at a fixed distance from the floater assembly 770. As the spring arms 780 receive force input from the springs 790, the spring arms 780 may push the floater assembly 770 directly upward from the springs 790, and/or may push on one of the spring arms 780 more than the other such that the floater assembly 770 changes orientation relative to the spring arms 780.

In some embodiments, the roller guide may be displaced to various locations both vertically and laterally as the floater assembly 770 responds to the spring force of the springs 790.

As illustrated in the embodiments of FIGS. 16A and 16B, the floater assembly 770 may utilize a passive force via the springs 790 that may operate at all times to continuously maintain contact between the centerless rim 730 and the floater assembly 770. Such embodiments may increase friction between the floater assembly 770 and the centerless rim 730 due to the increased force pushing the floater assembly 770 against the centerless rim 730.

In some embodiments, rather than the use of the springs 790, the spring arms 780 may be coupled to a servo motor or other device to change the location of the spring arms 780 in a vertical direction relative to the channels 792. In these and other embodiments, one or more sensors may be included such that variations in contact and/or variations in force between the interface of the floater assembly 770 and the centerless rim 730 may be utilized to drive the servo motor or other device to displace the spring arms 780.

Modifications, additions, or omissions may be made to the centerless wheel assembly 701 of FIGS. 16A and 16B without departing from the scope of the present disclosure. For example, any of the features and/or principles described with reference to other embodiments of the present disclosure may be applied to the centerless wheel assembly 701 illustrated in FIGS. 16A and 16B.

While embodiments of the present disclosure are described with reference to a “wheel,” it will be appreciated that the same principles and teachings are applicable to other similarly situated shapes or components. For example, the same principles described above with reference to wheels may be applicable to cogs or pinions, for example, for a tank or other tracked vehicle where the wheel may include a non-uniform outer surface and may or may not include a tire.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

The use of relative terms such as “approximately,” “around,” about,” “generally,” etc. are used herein as that term would be understood by an ordinarily skilled artisan in the pertinent art. For example, in some circumstances, such terms may mean within 10%, within 5% or within 1%. As another example, if two arms are “generally parallel,” it may be understand that they may be parallel within +/−five degrees of each other, etc. In some circumstances, such terms may mean within manufacturing tolerances. If one such term is used in one location, and not in another, it is to be understood that such a circumstance in no way conveys that the location that does not include the term is to be interpreted as being exact.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A vehicle comprising:
a vertical axle;
a support rod coupled to the vertical axle; and
a wheel assembly coupled to the vertical axle via the support rod, the wheel assembly comprising:
a centerless rim;
a stationary hub coupled to the support rod and disposed at least partially within the centerless rim; and
a roller guide supported by the stationary hub and shaped to roll along the centerless rim;
wherein the wheel assembly is configured to rotate at least one hundred and seventy degrees relative to the vehicle.

2. The vehicle of claim 1, wherein the vertical axle is configured to remain in a fixed position relative to the vehicle and rotate in the fixed position to cause the wheel assembly to rotate.

3. The vehicle of claim 1, wherein the vertical axle is configured to move relative to the vehicle while the wheel assembly rotates.

4. The vehicle of claim 3, wherein the vertical axle follows a fixed motion while the wheel assembly rotates.

5. The vehicle of claim 1, wherein the roller guide is at an angle of between five degrees and forty five degrees relative to the ground when rolling along the centerless rim.

6. The vehicle of claim 1, wherein the roller guide is spring-loaded to be biased towards the centerless rim.

7. The vehicle of claim 1 wherein the stationary hub includes an arm extending distally away from a central region of the stationary hub and the roller guide is supported at a distal region of the arm.

8. The vehicle of claim 1, further comprising a motor coupled to the stationary hub to provide motive force to the wheel assembly.

9. The vehicle of claim 8, wherein:
the centerless rim includes a rim gear, teeth of the rim gear oriented towards a middle of the centerless rim;
an output of the motor is coupled to a drive gear, the drive gear configured to interface with the rim gear such that the output of the motor rotates the drive gear, causing rotation of the rim gear and the centerless rim.

10. The vehicle of claim 9, further comprising a battery coupled to and providing power to the motor.

11. The vehicle of claim 10, wherein the battery is physically coupled to the stationary hub.

12. The vehicle of claim 10, wherein the battery is stored in the vehicle away from the wheel assembly.

13. The vehicle of claim 10, further comprising a clutch between the motor and the drive gear configured to selectively engage the drive gear with the output of the motor.

14. The vehicle of claim 13, wherein the clutch is engageable when the centerless rim rotates faster than the output of the motor such that the motor provides a load via the drive gear and generates power provided to the battery.

15. The vehicle of claim 1, wherein the wheel assembly is configured to rotate at least two hundred degrees relative to the vehicle.

16. The vehicle of claim 15, wherein the wheel assembly is configured to rotate in two different directions to a position perpendicular to a forward-facing orientation of the vehicle.

17. The vehicle of claim 1, further comprising two or more additional wheel assemblies, wherein each of the wheel assembly and the two or more additional wheel assemblies are configured to rotate in an individually different but coordinated manner to turn the vehicle.

18. A wheel assembly comprising:
a stationary hub, the stationary hub comprising:
a plurality of arms extending outwardly from a central region of the stationary hub;
a support arm link shaped to interface with a support arm of a vehicle;
an axle connector projecting outward from a middle of the stationary hub; and
a brake caliper;
a plurality of roller guides, each supported at an end portion of one of the plurality of arms;
a centerless rim, shaped to interface with the plurality of roller guides such that the plurality of roller guides roll along the centerless rim when the centerless rim rotates relative to the stationary hub, the centerless rim comprising:
a rim gear with teeth oriented towards a middle of the centerless rim;
an internal slanted portion angled inwards towards the rim gear and shaped to interface with at least one of the plurality of roller guides; and
an external slanted portion on an opposite side from the rim gear and angled inwards towards the rim gear and shaped to interface with at least another of the plurality of roller guides; and
a brake rotor physically coupled to the centerless rim such that slowing of the brake rotor causes a corresponding slowing of the centerless rim, the brake rotor positioned to correspond to the brake caliper such that when the brake caliper is activated, the brake rotor is slowed.

19. The wheel assembly of claim 18, wherein for each of the plurality of roller guides, a supporting axle is oriented at an angle of between fifteen and forty-five degrees relative to an axis through the center point of the centerless rim and perpendicular to the plane through the rim gear.

20. The wheel assembly of claim 19, wherein the roller guides include a frustoconical shape.
